(19) United States
(12) Patent Application Publication
(10) Pub. No.: US 2025/0377850 A1
(43) Pub. Date: Dec. 11, 2025

(54) METHOD OF CONTROLLING COMMUNICATION WITH DISPLAY DEVICE AND DISPLAY SYSTEM

(71) Applicant: SEIKO EPSON CORPORATION, Tokyo (JP)

(72) Inventor: Hirohiko KIHARA, MATSUMOTO-SHI (JP)

(21) Appl. No.: 19/232,145

(22) Filed: Jun. 9, 2025

(30) Foreign Application Priority Data
Jun. 10, 2024 (JP) 2024-093587

(51) Int. Cl. G06F 3/14; G06F 21/60; G06F 21/84; G09G 5/14; H04N 9/31

(52) U.S. Cl. CPC G06F 3/1454; G06F 21/606; G06F 21/84; G09G 5/14; H04N 9/3179; G09G 2358/00; G09G 2360/04; G09G 2370/06; G09G 2370/16; G09G 2370/22

(57) ABSTRACT

A display system includes a plurality of communication terminals and a monitor capable of communicating with the plurality of communication terminals, the monitor is capable of displaying an image in a display region, first communication between a first communication terminal among the plurality of communication terminals and the monitor is established, when authorization of second communication between a second communication terminal among the plurality of communication terminals and the monitor is requested from the second communication terminal while the image is displayed in the display region, the monitor transmits, to the first communication terminal, information indicating that the authorization of the second communication is requested, the first communication terminal outputs, to the first communication terminal, information for causing a user of the first communication terminal to determine whether to approve the authorization of the second communication, and the monitor establishes the second communication when information indicating that the authorization of the second communication was approved is received from the first communication terminal.

The present application is based on, and claims priority from JP Application Serial Number 2024-093587, filed Jun. 10, 2024, the disclosure of which is hereby incorporated by reference herein in its entirety.

### BACKGROUND

### 1. Technical Field

The present disclosure relates to a method of controlling communication with a monitor and a display system.

### 2. Related Art

In related art, in order to cause a monitor such as a projector to display an image, a device such as a computer establishes communication between the device such as the computer and the monitor. For example, JP-A-2018-152663 discloses that a projector displays an image including an identification code on a projection surface in response to predetermined operation such as power-on and a user who uses the projector inputs the identification code displayed on the projection surface to an information terminal, whereby the projector establishes connection to the information terminal.

JP-A-2018-152663 is an example of the related art.

However, when a plurality of devices are made connectable to one monitor, the following problem arises. Specifically, a situation is conceivable in which, while the monitor is displaying an image based on image data transmitted from a device that has already established connection to the monitor, a device that has not established connection to the monitor requests communication with the monitor. In this situation, if the monitor executes predetermined operation and displays an image including an identification code, there is a problem that the display of the image based on the image data transmitted from the device that has established connection is hindered.

### SUMMARY

A method of controlling communication with a monitor according to an aspect of the present disclosure is a method of, in a display system including a plurality of communication terminals and a monitor capable of communicating with the plurality of communication terminals, controlling communication with the monitor, the method including: establishing, with the monitor capable of displaying an image in a display region, first communication with a first communication terminal among the plurality of communication terminals; when authorization of second communication between a second communication terminal among the plurality of communication terminals and the monitor is requested from the second communication terminal while the image is displayed in the display region, transmitting, with the monitor, information indicating that the authorization of the second communication is requested; outputting, with the first communication terminal, to the first communication terminal, information for causing a user of the first communication terminal to determine whether to approve the authorization of the second communication; and establishing, with the monitor, the second communication when information indicating that the authorization of the second communication was approved is received from the first communication terminal.

A display system according to an aspect of the present disclosure is a display system including: a plurality of communication terminals; and a monitor capable of communicating with the plurality of communication terminals, wherein the monitor is capable of displaying an image in a display region, first communication between a first communication terminal among the plurality of communication terminals and the monitor is established, when authorization of second communication between a second communication terminal among the plurality of communication terminals and the monitor is requested from the second communication terminal while the image is displayed in the display region, the monitor transmits, to the first communication terminal, information indicating that the authorization of the second communication is requested, the first communication terminal outputs, to the first communication terminal, information for causing a user of the first communication terminal to determine whether to approve the authorization of the second communication, and the monitor establishes the second communication when information indicating that the authorization of the second communication was approved is received from the first communication terminal.

### BRIEF DESCRIPTION OF THE DRAWINGS

FIG. 1 is a diagram illustrating a display system according to a first embodiment.

FIG. 2 is a diagram illustrating an example of a configuration of a PC.

FIG. 3 is a diagram illustrating an example of a configuration of a projector.

FIG. 4 is a sequence diagram illustrating an example of an operation of the display system.

FIG. 5 is a flowchart illustrating an example of an operation of the projector.

FIG. 6 is a flowchart illustrating an example of communication request reception time processing.

FIG. 7 is a diagram illustrating an example of a communication determination image.

FIG. 8 is a flowchart illustrating an example of an operation of the projector in a first modification.

FIG. 9 is a flowchart illustrating an example of communication request reception time processing in the first modification.

FIG. 10 is a flowchart illustrating an example of an operation of the projector in a second modification.

FIG. 11 is a flowchart illustrating an example of image data reception time processing.

FIG. 12 is a flowchart illustrating an example of an operation of the projector in a third modification.

FIG. 13 is a flowchart illustrating an example of an operation of image data reception time processing in the third modification.

FIG. 14 is a diagram illustrating a state immediately before a mode is changed to a hold mode.

FIG. 15 is a diagram illustrating a state after the mode is changed to the hold mode.

FIG. 16 is a flowchart illustrating an example of authorization request information transmission processing.

FIG. 17 is a flowchart illustrating an example of authorization request information transmission processing in a fourth modification.

### DESCRIPTION OF EMBODIMENTS

Modes for implementing the present disclosure are explained below with reference to the drawings. Note that, in the drawings, dimensions and scales of portions are differentiated from actual ones as appropriate. Embodiments explained below are preferred specific examples of the present disclosure and, therefore, various technically preferable limitations are added to the embodiment. However, the scope of the present disclosure is not limited to these embodiments unless, in the following explanation, there is particular description to the effect that the present disclosure is limited thereto.

### 1. First Embodiment

### 1-1. Overview of a First Embodiment

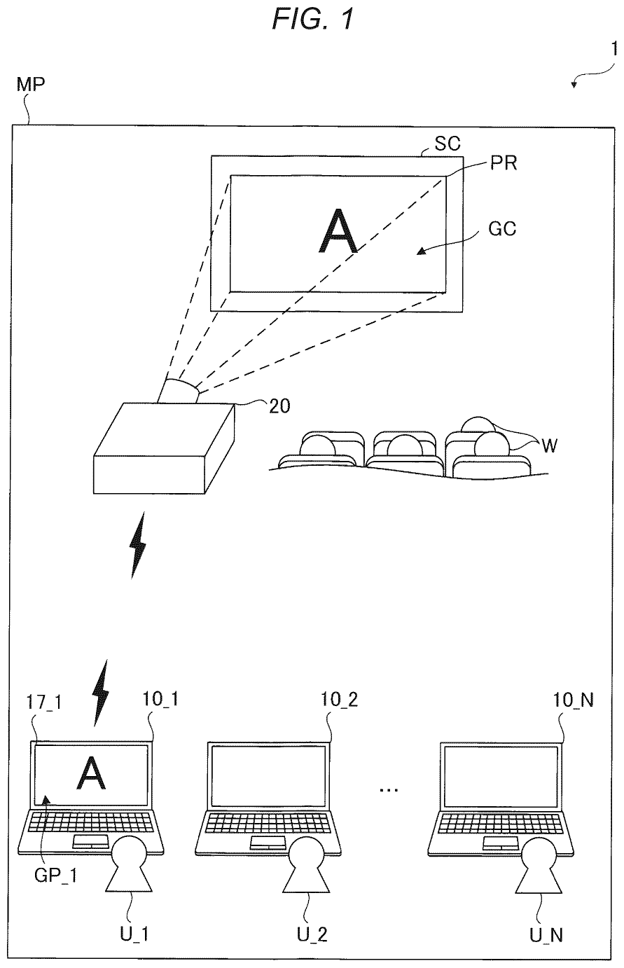

FIG. 1 is a diagram illustrating a display system 1 according to a first embodiment. The display system 1 is a system in which, in a venue MP, an image GC is projected onto a projection region PR of a projection surface SC visible from one or a plurality of spectators W and any one of two or more N presenters U explains the image GC. The venue MP is a place holding an event gathering the spectators W and may be either an indoor or outdoor place. The spectators W are specified or unspecified people. However, the spectators W may not be present and the presenters U other than the presenters U currently giving an explanation among the N presenters U may be temporary spectators. Examples of the event include a meeting, a lecture, and a class. In the present embodiment, a premise is that the N presenters U sequentially give explanations.

As illustrated in FIG. 1, the display system 1 includes N PCs 10 and a projector 20. PC is an abbreviation of Personal Computer. An i-th the PC 10_i among the N PCs 10 is operated by an i-th presenter U_i of N people. i is an integer from 1 to N. Note that, in the present embodiment, although an image GC projected onto a projection region PR by the presenter U_i who operates the PC 10_i is explained for simplicity of explanation, a person who operates the PC 10_i and a person who explains the image GC may be different persons. The N PCs 10 are an example of a “plurality of communication terminals”. The presenter U is an example of a “user”. Projecting an image is an example of “display an image”. The projector 20 is an example of a “monitor”. The projection region PR is an example of a “display region”. The plurality of communication terminals provided in the display system 1 are not limited to PCs and may be mobile terminals and smartphones.

In the following explanation, when elements of the same type are distinguished, reference signs are used like the PC 10_1 and the PC 10_2. On the other hand, when elements of the same type are not distinguished, only a common number of the reference signs is used like the PC 10.

The projector 20 is capable of communicating with the N PCs 10. In the present embodiment, the projector 20 and the N PCs 10 are communicating with each other by wireless communication. Examples of the wireless communication include Wi-Fi, Bluetooth, and ZigBee. Wi-Fi and Bluetooth are registered trademarks. However, the projector 20 and each of the N PCs 10 may be capable of communicating with each other via relay equipment such as a wireless router or may be capable of communicating with each other via a network such as a LAN, a WAN, or the Internet. LAN is an abbreviation of Local Area Network.

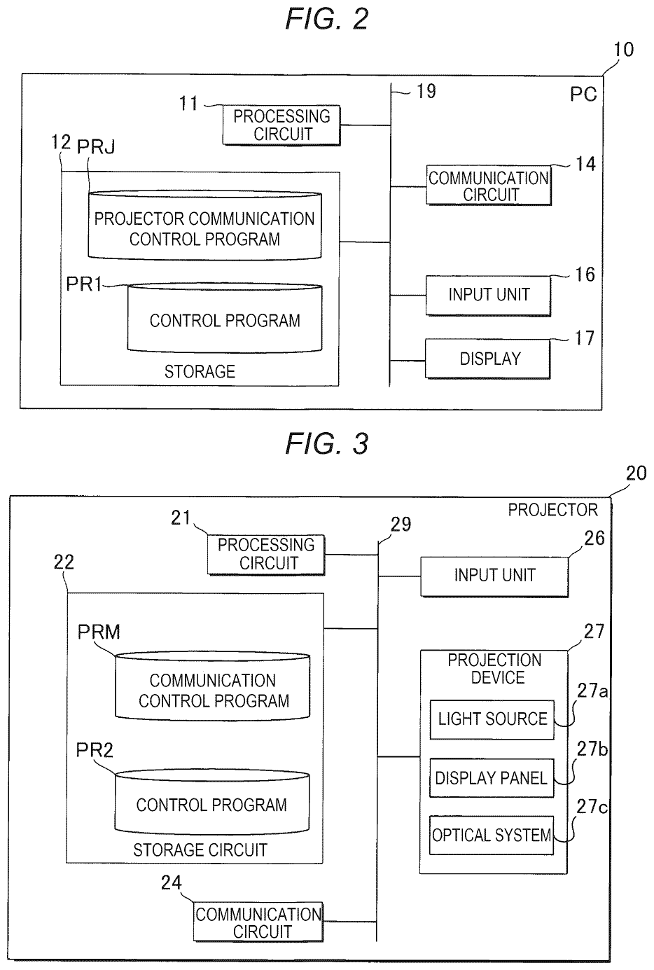

Configurations of the PC 10 and the projector 20 are explained with reference to FIGS. 2 and 3.

FIG. 2 is a diagram illustrating an example of the configuration of the PC 10. The PC 10 includes at least one processing circuit 11, a storage circuit 12, a communication circuit 14, an input unit 16, and a display 17. The processing circuit 11, the storage circuit 12, the communication circuit 14, the input unit 16, and the display 17 are coupled to one another by a bus 19 for communicating information.

The processing circuit 11 is a computer such as a CPU. The processing circuit 11 may be configured by one or a plurality of processors.

The storage circuit 12 is configured by a magnetic storage device, a flash ROM, or the like. The storage circuit 12 is a recording medium readable by the processing circuit 11 and stores a plurality of programs including a projector communication control program PRJ and a control program PR1 to be executed by the processing circuit 11, various information used by the processing circuit 11, and the like. The projector communication control program PRJ is an application program for controlling an operation of the PC 10 in the display system 1. For example, the PC 10 downloads the projector communication control program PRJ from a server managed by a developer of the projector 20. The control program PR1 is a system program including, for example, an OS of the PC 10.

The communication circuit 14 is hardware including a communication circuit for performing wireless communication with other devices such as the projector 20. The communication circuit 14 is also described as, for example, network device, network controller, network card, or communication module.

The input unit 16 is equipment for the presenter U to input information. The input unit 16 is, for example, a mouse and a keyboard.

The display 17 is equipment that displays an image based on image data transmitted by the processing circuit 11. For example, the display 17 is an LCD or an organic EL display. LCD is an abbreviation of Liquid Crystal Display. EL is an abbreviation of Electro Luminescence. The input unit 16 and the display 17 may be integrally configured. The configuration in which the input unit 16 and the display 17 are integral is, for example, a touch panel.

In the following description, elements of the PC 10_i are sometimes explained with a reference sign “_i” added thereto. For example, the display 17 provided in the PC 10_i is sometimes described as display 17_i. Further, an image displayed on the display 17_i is sometimes described as image GP_i.

FIG. 3 is a diagram illustrating an example of a configuration of the projector 20. The projector 20 includes at least one processing circuit 21, a storage circuit 22, a communication circuit 24, an input device 26, and a projection device 27. The processing circuit 21, the storage circuit 22, the communication circuit 24, the input device 26, and the projection device 27 are coupled to one another by a bus 29 for communicating information.

The processing circuit 21 is a computer such as a CPU. The processing circuit 21 may be configured by one or a plurality of processors.

The storage circuit 22 is configured by a magnetic storage device, a flash ROM, or the like. The storage circuit 22 is a recording medium readable by the processing circuit 21 and stores a plurality of programs including a control program PR2 and a communication control program PRM, various information used by the processing circuit 21, and the like. The control program PR2 is a system program including an OS of the projector 20. The communication control program PRM is a program for controlling an operation of the projector 20 in the display system 1.

The communication circuit 24 is hardware including a communication circuit for performing wireless communication with another device such as the PC 10. The communication circuit 24 is also described as, for example, a network device, a network controller, a network card, or a communication module.

The input device 26 is equipment for the presenter U to input information. The input device 26 is a plurality of buttons including, for example, a function list display key, an up key, a down key, a left key, a right key, an enter key, and a cancel key. Alternatively, the input device 26 may be configured by one or more types of devices such as a pointing device and a touch panel. Alternatively, the projector 20 may communicate with, instead of the input device 26, a remote controller including the plurality of buttons explained above.

The projection device 27 is a device that projects the image GC onto the projection region PR based on image data transmitted from the processing circuit 21. The projection device 27 includes a light source 27a, a display panel 27b, and an optical system 27c.

The light source 27a includes a light source such as a halogen lamp, a xenon lamp, an ultra-high pressure mercury lamp, an LED, or a laser light source and emits red, green, and blue light. LED is an abbreviation of Light Emitting Diode. The display panel 27b is a light modulator including three light modulation elements provided to correspond to red, green, and blue. The light modulation elements include, for example, transmissive liquid crystal panels, reflective liquid crystal panels, or digital mirror devices and modulate lights of colors corresponding thereto to thereby generate image lights of the colors. The image lights of the colors generated by the display panel 27b are combined together by a light combination optical system to be full color image light. The optical system 27c is a projection optical system including, for example, a projection lens that projects the full color image light from the display panel 27b onto the projection region PR to form the image GC.

Reference is made to FIG. 1 again. In the example illustrated in FIG. 1, the projector 20 communicates with the PC 10_1 and the image GP_1 displayed on a display 17_1 and the image GC projected onto the projection region PR are the same.

In the present specification, the image GP and the image GC being the same means that the image data transmitted to the display 17 by the processing circuit 11 and the image data transmitted to the projection device 27 by the processing circuit 21 are the same. Therefore, even if the color reproducibility of the display 17 and the color reproducibility of the projection device 27 are different, if the image data transmitted to the display 17 by the processing circuit 11 and the image data transmitted to the projection device 27 by the processing circuit 21 are the same, the image GP and the image GC are regarded as the same.

### 1-2. In the Progress of an Event

During the progress of an event, while a first presenter U_1 explains the image GC, a presenter U_2 who makes presentation next to the presenter U_1 requests to proceed with preparation for projection onto the projector 20. An example of the preparation for the projection is to establish connection between the PC 10_2 and the projector 20. The establishment of the connection means setting a logical communication path before starting data transfer. More specifically, the establishment of the connection means that the PC 10 logs in to a service in which the projector 20 projects an image. Alternatively, the establishment of the connection may be performing three-way handshake when TCP is used in the communication between the PC 10 and the projector 20. TCP is an abbreviation of Transmission Control Protocol. By the connection being established, the PC 10 can access the projector 20 and the presenter U can prepare for projection. In the following description, establishing the connection between the PC 10 and the projector 20 is sometimes described as “the PC 10 logs in to the projector 20”.

In general, a time when the presenter U can give an explanation is allocated in advance. When a problem in that the PC 10_2 cannot log in to the projector 20 occurs, if it takes time to solve the problem, it is likely that the time when the presenter U_2 can give an explanation decreases. Therefore, the PC 10_2 logs into the projector 20 while the presenter U_1 is explaining the image GC, whereby the presenter U_2 can proceed with the explanation without delay after the explanation of the presenter U_1 ends.

A method of the PC 10 logging in to the projector 20 is as follows. The projector 20 displays an image including an identification code in the projection region PR in response to predetermined operation such as power-on. The presenter U inputs the identification code displayed in the projection region PR to the PC 10, whereby the PC 10 logs in to the projector 20.

In order for the PC 10_2 to log in to the projector 20, a situation is conceivable in which the PC 10_2 requests the projector 20 to authorize connection to the projector 20 while the presenter U_1 is explaining the image GP. In this situation, if the projector 20 displays the image including the identification code in the projection region PR, there is a problem in that the display of the image GP based on the image data transmitted from the PC 10_1 is hindered. When the display of the image GP based on the image data transmitted from the PC 10_1 is hindered, the presenter U_1 cannot proceed with the explanation concerning the image GP. Further, the presenter U_1 needs to explain to the spectator W that the image including the identification code is irrelevant to the content explained by the presenter U_1.

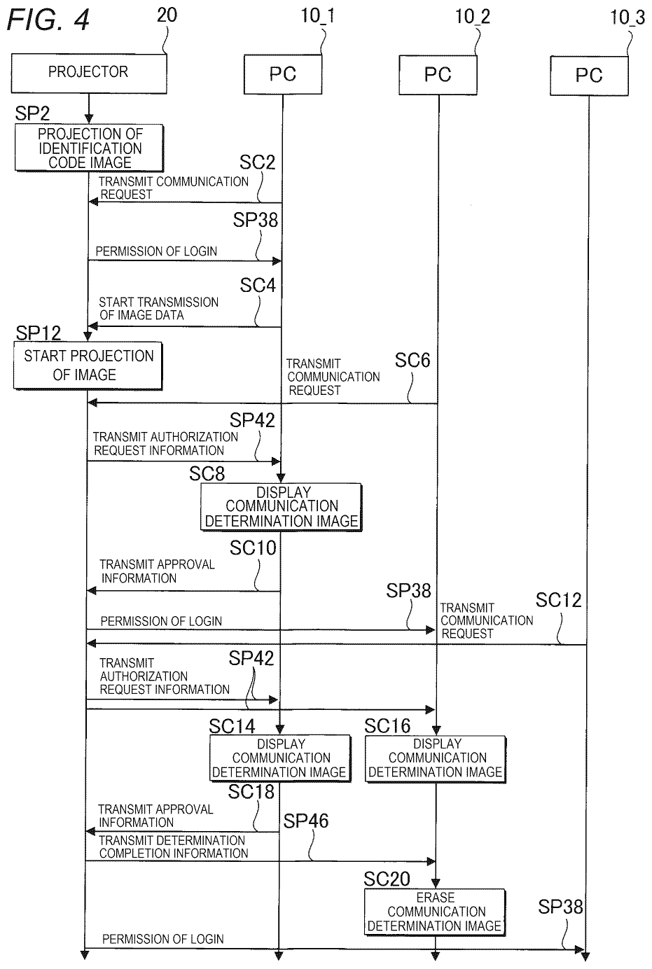

Thus, in the display system 1 according to the present embodiment, when the authorization of the communication between the PC 10_2 and the projector 20 is requested from the PC 10_2, the display system 1 notifies, to the PC 10_1, the authorization request information indicating that the authorization of the communication has been requested. In the following description, the request for authorization of communication is sometimes described as “communication request”. When receiving the authorization request information, the PC 10_1 outputs, to the display 17 of the PC 10_1, information for causing the presenter U_1 to determine whether to approve the authorization of the communication. The information for causing the presenter U_1 to determine whether to approve the authorization of the communication between the PC 10_2 and the projector 20 may be a character string indicating whether to approve the authorization of the communication between the PC 10_2 and the projector 20 or may be image data indicating an image. In the following description, the information for causing the presenter U_1 to determine whether to approve the authorization of the communication between the PC 10_2 and the projector 20 is image data indicating an image and is sometimes described as “communication determination image data”. When the projector 20 receives, from the PC 10_1, the information indicating that the authorization of the communication between the PC 10_2 and the projector 20 has been approved, the PC 10_2 logs in to the projector 20. Since the image indicated by the communication determination image data is not displayed in the projection region PR, the presenter U_1 can proceed with the explanation concerning the image GP without delay. An operation of the display system 1 is explained with reference to FIGS. 4, 5, and 6.

### 1-3. Operation of the Display System 1

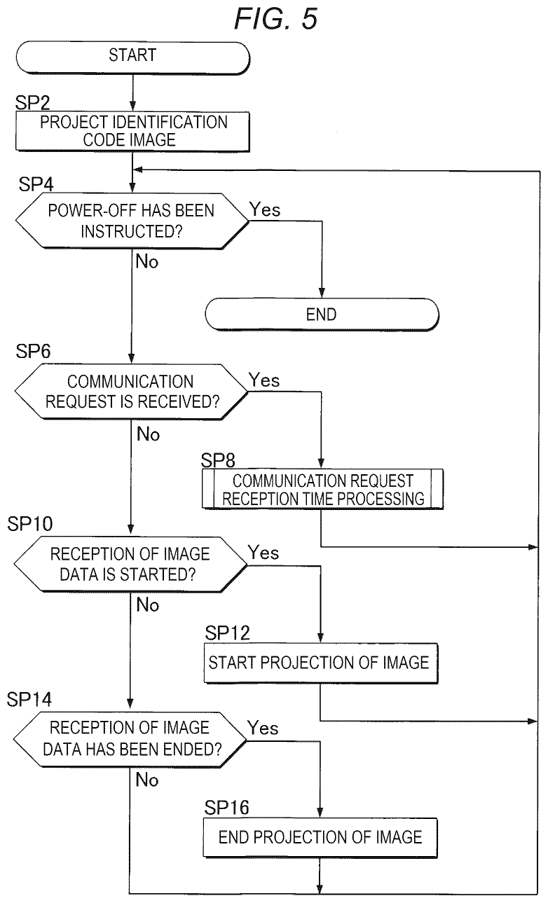

FIG. 4 is a sequence diagram illustrating an example of an operation of the display system 1. FIG. 5 is a flowchart illustrating an example of an operation of the projector 20. In FIG. 4, explanation is based on a premise that the PCs 10 provided in the display system 1 are the PC 10_1, the PC 10_2, and a PC 10_3. In the first embodiment, management authority for the projector 20 is set in the PC 10 logged in to the projector 20. Then, the projector 20 causes the presenter U of the PC 10 for which the management authority is set to determine whether to approve authorization of communication with the projector 20. In the following description, the PC 10 for which the management authority is set is sometimes described as “management authority PC 10_m”.

In the following description, the number of the plurality of PCs 10 of the display system 1 is three or more. The PC 10_1 is equivalent to a “first communication terminal”, the PC 10_2 is equivalent to a “second communication terminal”, and the PC 10_3 is equivalent to a “third communication terminal”. Communication between the PC 10_1 and the projector 20 is equivalent to “first communication”. Communication between the PC 10_2 and the projector 20 is equivalent to “second communication”. Communication between the PC 10_3 and the projector 20 is equivalent to “third communication”. The presenter U_1 is equivalent to a “user of the first communication terminal”. The presenter U_2 is equivalent to a “user of the second communication terminal”.

The processing circuit 21 of the projector 20 executes the operations illustrated in FIGS. 4 and 5 by reading the communication control program PRM from the storage circuit 22 and executing the read communication control program PRM. The processing circuit 11 of the PC 10 executes the operation illustrated in FIG. 4 by reading the projector communication control program PRJ from the storage circuit 12 and executing the read projector communication control program PRJ.

As illustrated in FIGS. 4 and 5, in step SP2, the processing circuit 21 projects an identification code image including an identification code onto the projection region PR after power-on. The identification code is, for example, a character string having a plurality of alphanumeric characters. Then, as illustrated in FIG. 5, in step SP4, the processing circuit 21 determines whether power-off has been instructed by, for example, pressing a power button of the projector 20. When a determination result in step SP4 is affirmative, the processing circuit 21 ends a series of processing illustrated in FIG. 5.

When the determination result in step SP4 is negative, in step SP6, as illustrated in FIG. 5, the processing circuit 21 determines whether a communication request has been received from the PC 10. When a determination result in step SP6 is affirmative, as illustrated in FIG. 5, the processing circuit 21 executes communication request reception time processing in step SP8.

In FIG. 4, explanation is based on a premise that the processing circuit 21 transmits a communication request including an identification code to the projector 20 in step SC2 according to input operation of the presenter U_1 after the processing in step SP2 ends.

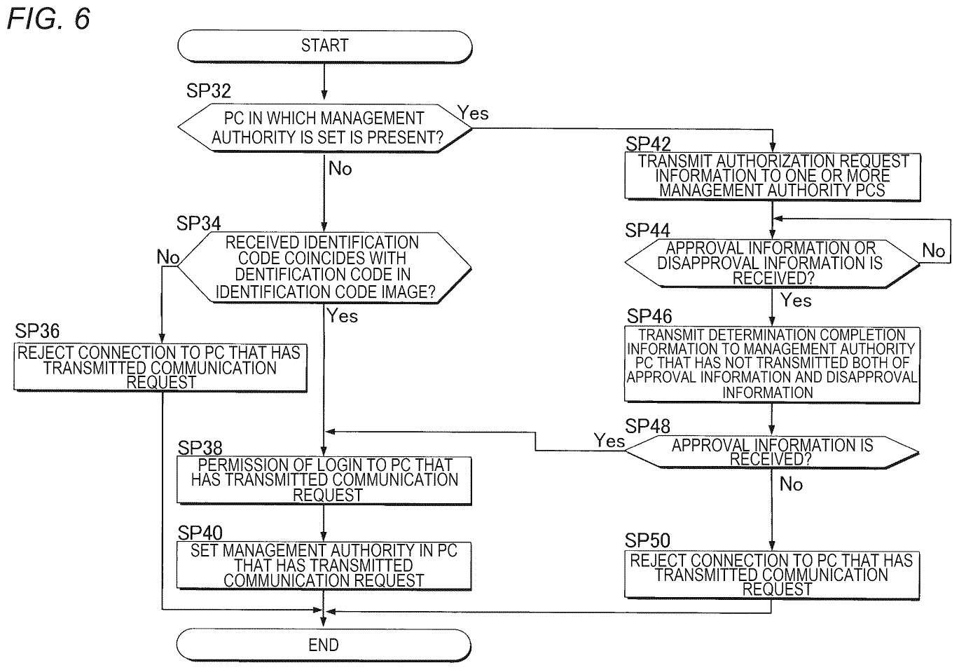

When receiving a communication request from the PC 10_1, which is the first the PC 10, the processing circuit 21 determines that the determination result in step SP6 is affirmative and executes the communication request reception time processing in step SP8. The communication request reception time processing is explained with reference to FIG. 6.

FIG. 6 is a flowchart illustrating an example of the communication request reception time processing. In step SP32, the processing circuit 21 determines whether the PC 10 in which the management authority is set is present.

In the example illustrated in FIG. 4, the PC 10 in which the management authority is set is absent at the stage of step SC2. Therefore, the processing circuit 21 determines that the determination result in step SP32 is negative. When the determination result in step SP32 is negative, as illustrated in FIG. 6, in step SP34, it is determined whether the received identification code coincides the identification code included in the identification code image. When a determination result in step SP34 is negative, in step SP36, the processing circuit 21 rejects the connection to the PC 10 that has transmitted the communication request and ends a series of processing illustrated in FIG. 6. Under the instruction of the processing circuit 21, as an example of the rejection of the connection to the PC 10, the communication circuit 24 transmits a rejection response to the PC 10 that has transmitted the communication request. The rejection response includes, for example, an identifier indicating that the identification code input by the user is wrong.

When the determination result in step SP34 is affirmative, as illustrated in FIGS. 4 and 6, in step SP38, the processing circuit 21 gives permission for login to the PC 10_1, which is the PC 10 that has transmitted the communication request, and the PC 10_1 logs in to the projector 20. Subsequently, as illustrated in FIG. 6, in step SP40, the processing circuit 21 sets the management authority in the PC 10 that has transmitted the communication request and ends the series of processing illustrated in FIG. 6.

Reference is made to FIGS. 4 and 5 again. After the processing in step SP8 ends, the processing circuit 21 executes the processing in step SP4 again.

When the determination result in step SP6 is negative, as illustrated in FIG. 5, in step SP10, the processing circuit 21 determines whether reception of image data is started from the PC 10 logged in to the projector 20.

In the example illustrated in FIG. 4, in step SC4, the PC 10_1 that has logged in to the projector 20 starts transmitting image data to the projector 20. In the example illustrated in FIG. 4, the processing circuit 21 determines that a determination result in step SP10 is affirmative. When the determination result in step SP10 is affirmative, as illustrated in FIGS. 4 and 5, in step SP12, based on an instruction of the processing circuit 21, the projection device 27 starts projecting an image based on the received image data. The image based on the image data may be the image itself indicated by the image data, may be a partial image of the image indicated by the image data, or may be an image obtained by superimposing another image on the image indicated by the image data or the partial image of the image. The other image is, for example, a character string indicating the present time or an OSD image in which the position and the contrast of the image can be operated. OSD is an abbreviation of On Screen Display.

In step SP12, when image data is received from two or more PCs 10, the projection device 27 projects an image based on the image data received from each of the two or more PCs 10 in regions obtained by dividing the projection region PR. After the processing in step SP12 ends, the processing circuit 21 executes the processing in step SP4 again.

When the determination result in step SP10 is negative, as illustrated in FIG. 5, in step SP14, the processing circuit 21 determines whether the reception of the image data has been ended. When a determination result in step SP14 is affirmative, as illustrated in FIG. 5, in step SP16, based on an instruction of the processing circuit 21, the projection device 27 ends the projection of the image based on the received image data.

In step SP16, when the image data is received from three or more PCs 10 and the reception of the image data from one PC 10 is ended, the projection device 27 reduces the number of divisions of the projection region PR and then projects an image based on the image data received from each of the two or more PCs 10. When the image data is received from two PCs 10 and the reception of the image data from one PC 10 is ended, the projection device 27 releases the division of the projection region PR and projects an image based on the image data received from the remaining one PC 10.

After the processing in step SP16 ends, the processing circuit 21 executes the processing in step SP4 again. When the determination result in step SP14 is negative, the processing circuit 21 also executes the processing in step SP4 again.

In FIG. 4, explanation is based on a premise that, after the projection device 27 starts projecting an image in step SP12, in step SC6, the PC 10_2 transmits, to the projector 20, a communication request to the projector 20. Therefore, the processing circuit 21 determines that the determination result in step SP6 is affirmative and further determines that the determination result in step SP32 is affirmative because there is one PC 10 in which the management authority is set in step SP32 in FIG. 6.

Reference is made to FIGS. 4 and 6 again. When the determination result in step SP32 is affirmative, in step SP42, the communication circuit 24 transmits authorization request information to one or more management authority PCs 10_m, in the example illustrated in FIG. 4, the PC 10_1, under an instruction of the processing circuit 21. The authorization request information is information indicating that the PC 10 has been requested to authorize communication with the projector 20 and is information necessary for the presenter U to determine whether the PC 10 approves the authorization of the communication with the projector 20. The authorization request information is, for example, information concerning the PC 10 that has transmitted the communication request to the projector 20. For example, the authorization request information includes a name of the PC 10 that has requested permission of communication and an account ID of an account logged in to the PC 10. ID is an abbreviation of Identification.

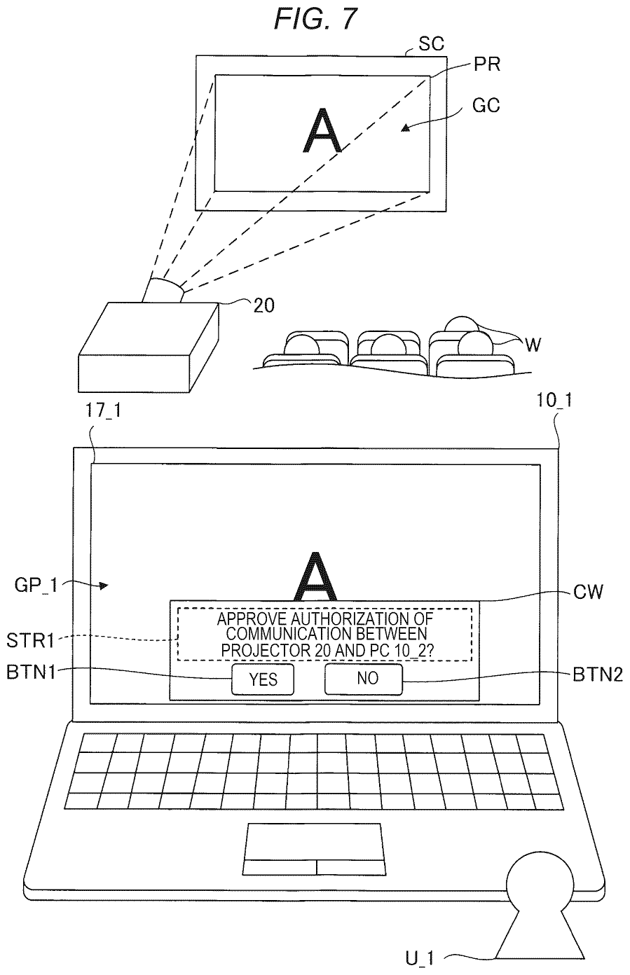

The processing circuit 11 of the PC 10 that has received the authorization request information, in the example illustrated in FIG. 4, the PC10_1, generates communication determination image data based on the authorization request information as illustrated in FIG. 4 and displays a communication determination image CW indicated by the communication determination image data on the display 17 in step SC8. A display example of the communication determination image CW is explained with reference to FIG. 7.

FIG. 7 is a diagram illustrating an example of the communication determination image CW. As illustrated in FIG. 7, the display 17 superimposes the communication determination image CW on the image GP_1. In the example illustrated in FIG. 7, the communication determination image CW includes a character string STR1, a button BTN1, and a button BTN2. The character string STR1 is “approve authorization of communication between the projector 20 and the PC 10_2?”. The button BTN1 is a button for, by being pressed by the presenter U, transmitting, to the projector 20, approval information indicating that the authorization of the communication with the projector 20 has been approved. The button BTN2 is a button for transmitting, to the projector 20, disapproval information indicating that the authorization of the communication with the projector 20 has been disapproved.

As illustrated in FIG. 7, the communication determination image CW is displayed on the display 17_1 but is not projected onto the projection region PR.

Reference is made to FIGS. 4 and 6 again. After the processing in step SP42 ends, as illustrated in FIG. 6, in step SP44, the processing circuit 21 determines whether the approval information or the disapproval information has been received from any one of one or more management authority PCs 10_m. When a determination result in step SP44 is negative, the processing circuit 21 executes the processing in step SP44 again. In the example illustrated in FIG. 4, explanation is based on a premise that the button BTN1 is pressed by operation of the presenter U_1 and the PC 10_1 transmits the approval information to the projector 20 in step SC10. Therefore, the processing circuit 21 determines that the determination result in step SP44 is affirmative.

When the determination result in step SP44 is affirmative, in step SP46, under an instruction of the processing circuit 21, the communication circuit 24 transmits determination completion information to the management authority PC 10_m that has not transmitted both of the approval information and the disapproval information among the management authority PCs 10_m that have transmitted the authorization request information. When there is the management authority PC 10_m that has not received both of the approval information and the disapproval information, the projector 20 determines that the management authority PC 10_m has not transmitted both of the approval information and the disapproval information. The determination completion information is information indicating that the determination of whether to approve the authorization of communication has been completed. After step SC8 is processed, there is only one management authority PC 10_m and there is no management authority PC 10_m that has not transmitted both of the approval information and the disapproval information. Therefore, the processing circuit 21 does not execute substantial processing in step SP46.

After the processing in step SP46 ends, in step SP48, the processing circuit 21 determines whether the approval information has been received. When the determination result in step SP48 is affirmative, the processing circuit 21 executes the processing in step SP38 and, in the example illustrated in FIG. 4, gives login permission to the PC 10_2.

When the determination result in step SP48 is negative, that is, when the disapproval information is received, as illustrated in FIG. 6, in step SP50, the processing circuit 21 rejects connection to the PC 10 that has transmitted the communication request and ends the series of processing illustrated in FIG. 6. The processing in step SP50 is the same as the processing in step SP36. However, content of a rejection response in step SP50 may be different from the content of the rejection response in step SP36. The rejection response in step SP50 includes, for example, an identifier indicating that the authorization of the communication is disapproved by the user of the PC 10 having the management authority of the projector 20.

In the example illustrated in FIG. 4, explanation is based on a premise that, after the processing circuit 21 executes the processing in step SP38 and the PC 10_2 logs in to the projector 20, the PC 10_3 transmits a communication request to the projector 20 in step SC12.

When receiving the communication request, the processing circuit 21 determines that the determination results in step SP6 and step SP32 are affirmative. Then, in step SP42, the communication circuit 24 transmits authorization request information to one or more management authority PCs 10_m, in the example illustrated in FIG. 4, the PC 10_1 and the PC 10_2, under an instruction of the processing circuit 21. In step SC14, the PC 10_1 causes the display 17_1 to display the communication determination image CW. The communication determination image CW displayed on the display 17_1 is an image for causing the presenter U_1 to determine whether to approve authorization of communication between the PC 10_3 and the projector 20. In step SC16, the PC 10_2 causes the display 17_2 to display the communication determination image CW. The communication determination image CW displayed on the display 17_2 is an image for causing the presenter U_2 to determine whether to approve the authorization of the communication between the PC 10_3 and the projector 20.

In the example illustrated in FIG. 4, explanation is based on a premise that the processing circuit 11_1 of the PC 10_1 transmits the approval information to the projector 20 in step SC18 based on operation of the presenter U_1. In the example illustrated in FIG. 4, explanation is based on a premise that the PC 10_2 does not transmit both of the approval information and the disapproval information. Therefore, as illustrated in FIG. 4, in step SP46, the communication circuit 24 transmits the determination completion information to the PC 10_2 under an instruction of the processing circuit 21. As illustrated in FIG. 4, when receiving the determination completion information, in step SC20, the PC 10_2 erases the communication determination image CW displayed on the display 17_2. Since the projector 20 has received the approval information, as illustrated in FIG. 4, in step SP38, the processing circuit 21 gives login permission to the PC 10_3, which is the PC 10 that has transmitted the communication request, and the PC 10_3 logs in to the projector 20.

Note that, in FIG. 4, the projector 20 gives the login permission to the PC 10_3 after transmitting the determination completion information to the PC 10_2 but may transmit the determination completion information to the PC 10_2 after giving the login permission to the PC 10_3.

### 1-4. Summary of the First Embodiment

In the following description, a summary of the first embodiment is explained with communication between the PC 10_1 and the projector 20 described as first communication, communication between the PC 10_2 and the projector 20 described as second communication, and communication between the PC 10_3 and the projector 20 described as third communication.

The display system 1 according to the first embodiment is the display system 1 including the plurality of PCs 10 and the projector 20 capable of communicating with the plurality of PCs 10. Further, the display system 1 executes a method of controlling communication with the projector 20. The projector 20 capable of projecting an image onto the projection region PR establishes the first communication with the PC 10_1 among the plurality of PCs 10 in step SP38. Further, when authorization of the second communication is requested from the PC 10_2 among the plurality of PCs 10 in step SP42 while the projector 20 is projecting the image onto the projection region PR in step SP12, the projector 20 transmits, to the PC 10_1, the authorization request information indicating that the authorization of the second communication has been requested. The PC 10_1 outputs communication determination image data, which is information for causing the presenter U_1 to determine whether to approve the authorization of the second communication, to the display 17_1 of the PC 10_1. The display 17_1 is an example of an output destination of information for causing the presenter U_1 to determine whether to approve the authorization of the second communication. When receiving, from the PC 10_1, approval information indicating that the authorization of the second communication has been approved, the projector 20 establishes the second communication.

According to the first embodiment, the communication determination image CW indicated by the communication determination image data is displayed on the display 17_1 but is not projected onto the projection region PR. Therefore, the projection of the image GP_1 based on the image data transmitted from the PC 10_1 is not hindered. Further, the PC 10_2 can log in to the projector 20. Therefore, according to the first embodiment, the PC 10_2 can log in to the projector 20 while preventing the display of the image GP_1 based on the image data transmitted from the PC 10_1 from being hindered.

The plurality of PCs 10 are three or more communication terminals and each of the three or more communication terminals includes the display 17, and the first communication and the second communication are established. When authorization of the third communication is requested from the PC 10_3 among the three or more PCs 10 while the image is displayed in the projection region PR, in step SP42, the projector 20 transmits, to the PC 10_1 and the PC 10_2, authorization request information indicating that the authorization of the third communication has been requested. In step SC14, the PC 10_1 outputs communication determination image data, which is information for causing the presenter U_1 of the PC 10_1 to determine whether to approve the authorization of the third communication, to the display 17_1 of the PC 10_1. In step SC16, the PC 10_2 outputs communication determination image data, which is information for causing the presenter U_2 of the PC 10_2 to determine whether to approve the authorization of the third communication, to the display 17_2 of the PC 10_2. When, in step SP44, receiving, from at least one PC 10 of the PC 10_1 and the PC 10_2, approval information indicating that the authorization of the third communication has been approved, the projector 20 establishes the third communication.

According to the first embodiment, the PC 10_3 can establish communication with the projector 20 while preventing display of the image GP_1 based on the image data transmitted from the PC 10_1 from being hindered. Further, the presenter U_1 or the presenter U_2 only has to press the button BTN1 or the button BTN2 of the communication determination image CW. Therefore, according to the first embodiment, it is possible to prevent approval of the authorization of the third communication from being delayed because of a deficiency such as a delay in communication of the display system 1 or carelessness of the presenter U compared with an aspect in which one presenter U presses the button BTN1 or the button BTN2 of the communication determination image CW.

Further, in response to receiving, from one PC 10 of the PC 10_1 and the PC 10_2, the approval information indicating that the authorization of the third communication has been approved or the disapproval information indicating that the authorization of the third communication has not been approved, in step SP46, the projector 20 transmits, to the other PC 10 of the PC 10_1 and the PC 10_2, the determination completion information indicating that the determination of whether to approve the authorization of the third communication has been completed.

According to the first embodiment, since the determination completion information is transmitted to the other PC 10, the communication determination image CW displayed on the display 17 of the other PC 10 can be erased and a burden of operation on the presenter U of the other PC 10 can be reduced.

In the first embodiment, when the determination result in step SP44 is affirmative, in step SP46, the projector 20 transmits the determination completion information to the management authority PC 10_m that has not transmitted both of the approval information and the disapproval information but is not limited to this. For example, when receiving the approval information, the projector 20 may transmit the determination completion information to the management authority PC 10_m explained above after establishing the communication with the PC 10 that has transmitted the communication request. When receiving the disapproval information, the projector 20 may transmit the determination completion information to the management authority PC 10_m explained above after rejecting the connection to the PC 10 that has transmitted the communication request.

### 2. Modifications

The modes exemplified above can be variously modified. Specific aspects of modifications applicable to the modes explained above are exemplified. Two or more aspects optionally selected from the following exemplifications can be combined with one another as appropriate to the extent that no contradiction occurs.

### 2-1. First Modification

In the first embodiment, when there are two or more management authority PCs 10_m, the projector 20 transmits the authorization request information to all the management authority PCs 10_m. On the other hand, in a first modification, when there are two or more management authority PCs 10_m, the projector 20 transmits the authorization request information to the PC 10 different from the PC 10 that causes the projector 20 to project an image. The first modification is explained below.

### 2-1-1. Operation of the First Modification

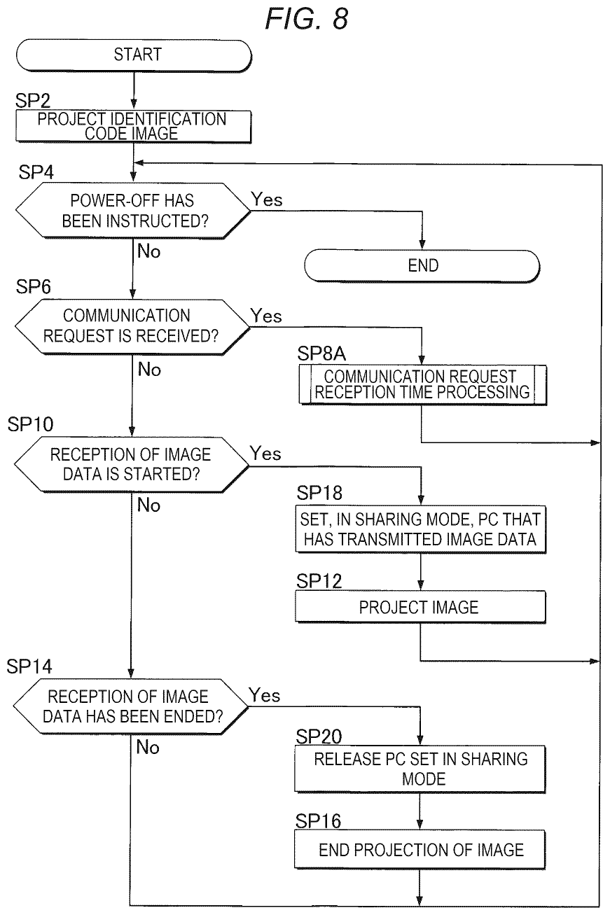

FIG. 8 is a flowchart illustrating an example of an operation of the projector 20 in the first modification. The flowchart illustrated in FIG. 8 is different from the flowchart illustrated in FIG. 5 in that the processing in step SP18 is executed when the determination result in step SP10 is affirmative, the processing in step SP20 is executed when the determination result in step SP14 is affirmative, and step SP8A is executed instead of step SP8 and is the same as the flowchart illustrated in FIG. 5 in the other parts. Only differences from the flowchart illustrated in FIG. 5 are explained below.

When the determination result in step SP10 is affirmative, in step SP18, the processing circuit 21 of the projector 20 sets, in a sharing mode, the PC 10 that has transmitted the image data. The sharing mode is a mode for causing the projector 20 to display an image based on image data transmitted from one or more PCs 10 among the three or more PCs 10 provided in the display system 1. In the following description, the image based on the image data transmitted from one or more PCs 10 is sometimes described as “shared image”. The PC 10 that has transmitted the image data indicating the shared image is sometimes described as a “sharing source PC 10_c”. Among the two or more management authority PCs 10_m, the PC 10 that is not the sharing source PC 10_c is sometimes described as “unshared PC 10_d”. The display 17 of the sharing source PC 10_c is sometimes described as a “display 17_c” and the presenter U of the sharing source PC 10_c is sometimes described as “presenter U_c”. The display 17 of the unshared PC 10_d is sometimes described as “display 17_d”.

The sharing mode is an example of a “first mode”. The shared image is an example of a “first image”. When there are two management authority PCs 10_m, the sharing source PC 10_c is an example of “one device” and the unshared PC 10_d is an example of “the other device”.

The shared image has the following two aspects. A shared image in a first aspect is the same as an image displayed on the display 17_c of the sharing source PC 10_c. In the following explanation, the shared image in the first aspect is sometimes described as “mirroring image”.

A shared image in a second aspect is different from the image displayed on the display 17_c of the sharing source PC 10_c. Specifically, the shared image in the second aspect is a partial image of the image displayed on the display 17_c. The partial image of the image displayed on the display 17_c is, for example, an image obtained by enlarging a part of the image displayed on the display 17_c or an image in a window of an application program displayed on the display 17_c. The application program may be any program and is, for example, a program for creating a document and a program for displaying a document. In the following explanation, the shared image in the second aspect is sometimes described as “partially shared image”.

After the processing in step SP18 ends, the processing circuit 21 ends the processing in step SP12.

When the determination result in step SP14 is affirmative, in step SP20, the processing circuit 21 releases the PC 10 set in the sharing mode.

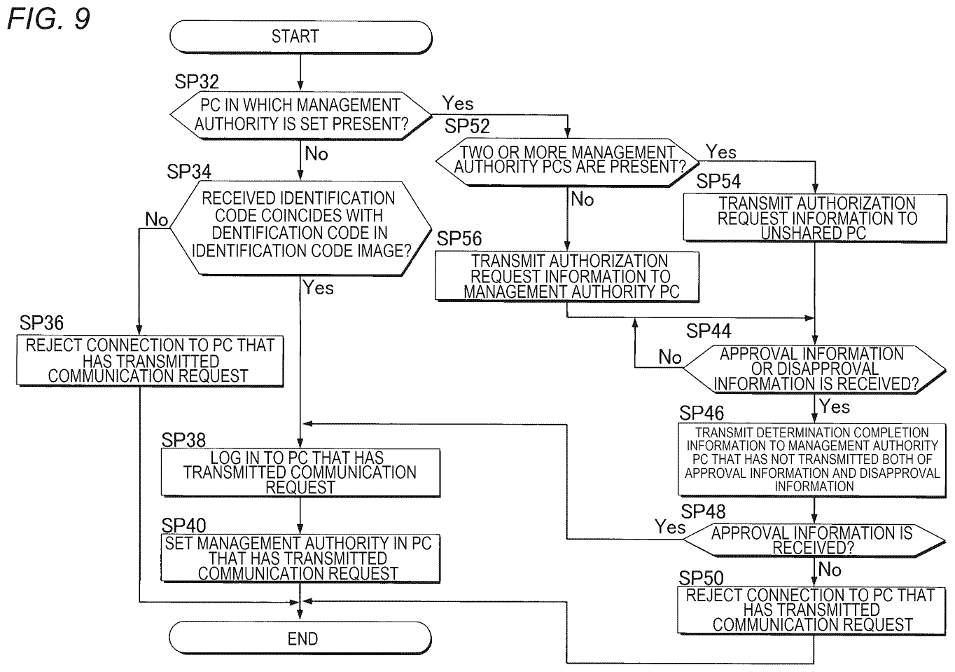

When the determination result in step SP6 is affirmative, in step SP8A, the processing circuit 21 executes communication request reception time processing in the first modification. The communication request reception time processing in the first modification is explained with reference to FIG. 9.

FIG. 9 is a flowchart illustrating an example of the communication request reception time processing in the first modification. The flowchart illustrated in FIG. 9 is different from the flowchart illustrated in FIG. 6 in that the processing in step SP52 is executed when the determination result in step SP32 is affirmative and the processing in step SP54 or step SP56 is executed after the processing in step SP52 ends and is the same as the flowchart illustrated in FIG. 6 in other parts. In the following explanation, only differences from the flowchart illustrated in FIG. 6 are explained.

When the determination result in step SP32 is affirmative, in step SP52, the processing circuit 21 determines whether two or more management authority PCs 10 is 2 are present. When the determination result in step SP52 is affirmative, in step SP54, the communication circuit 24 transmits the authorization request information to the unshared PC 10_d among the two or more management authority PCs under an instruction of the processing circuit 21. On the other hand, when the determination result in step SP52 is negative, in step SP56, the communication circuit 24 transmits the authorization request information to the management authority PC 10_m under an instruction of the processing circuit 21. After the processing in step SP54 or step SP56 ends, the processing circuit 21 executes the processing in step SP44.

### 2-1-2. Summary of the First Modification

In the following description, a summary of the first modification is explained using an example in which the communication between the PC 10_1 and the projector 20 is described as first communication, the communication between the PC 10_2 and the projector 20 is described as second communication, the communication between the PC 10_3 and the projector 20 is described as third communication, and the PC 10_1 and the PC 10_2 are set as the management authority PCs.

In the display system 1 in the first modification, there are three or more PCs 10 as the plurality of PCs 10, each of the three or more PCs 10 includes the display 17, the first communication and the second communication are established, and one PC 10 of the PC 10_1 and the PC 10_2 is set in the sharing mode. That is, one PC 10 is the sharing source PC 10_c. The sharing source PC 10_c is an example of “one device”. When authorization of the third communication is requested from the PC 10_3 among the three or more PCs 10 while the shared image is displayed in the projection region PR, in step SP52, the projector 20 notifies, to the unshared PC 10_d, authorization request information indicating that the authorization of the third communication has been requested. The unshared PC 10_d is an example of “the other device”. The unshared PC 10_d outputs, to the display 17_d of the unshared PC 10_d, communication determination image data, which is information for causing a user of the other device to determine whether to approve the authorization of the third communication. When receiving, from the unshared PC 10_d, approval information indicating that the authorization of the third communication has been approved, the projector 20 establishes the third communication.

According to the first modification, since the display 17_d of the unshared PC 10_d that does not cause the projector 20 to project an image displays the communication determination image CW indicated by the communication determination image data, it is possible to prevent the presenter U_c of the sharing source PC 10_c that is displaying an image on the projector 20 from being bothered.

The mirroring image that is the shared image in the first aspect is the same as the image displayed on the display 17_c of the sharing source PC 10_c.

Since the presenter U_c of the sharing source PC 10_c sometimes explains an image displayed on the display 17_c while viewing the image, if the communication determination image CW is displayed on the display 17_c, it is likely that the explanation concerning the image displayed on the display 17_c is interrupted and the presenter U_c feels annoyed. Therefore, according to the first modification, since it is possible to prevent the communication determination image CW from being displayed on the same image as the image projected by the projector 20, it is possible to prevent the presenter U_c from feeling annoyed.

The partially shared image, which is the shared image in the second aspect, is different from the image displayed on the display 17_c of the sharing source PC 10_c.

A related image relating to the image projected by the projector 20 is sometimes displayed on the display 17_c. The related information is, for example, one or both of an image showing a document to be read by the presenter U_c for explanation and an image showing a timer for observing a time allocated to the presenter U_c. If the communication determination image CW is displayed on the display 17_c, it is likely that the related image is hidden by the communication determination image CW and the presenter U_c feels annoyed. According to the first modification, since it is possible to prevent the communication determination image CW from being superimposed and displayed on the related image, it is possible to prevent the presenter U_c from feeling annoyed.

### 2-2. Second Modification

A second modification is different from the first embodiment and the first modification in that, when the sharing source PC 10_c is in a mode for displaying an image in the projection region PR while occupying the projection region PR, the PC 10 logged in to the projector 20 anew rejects to cause the projector 20 to display an image. The second modification is explained below.

### 2-2-1. Operation of the Second Modification

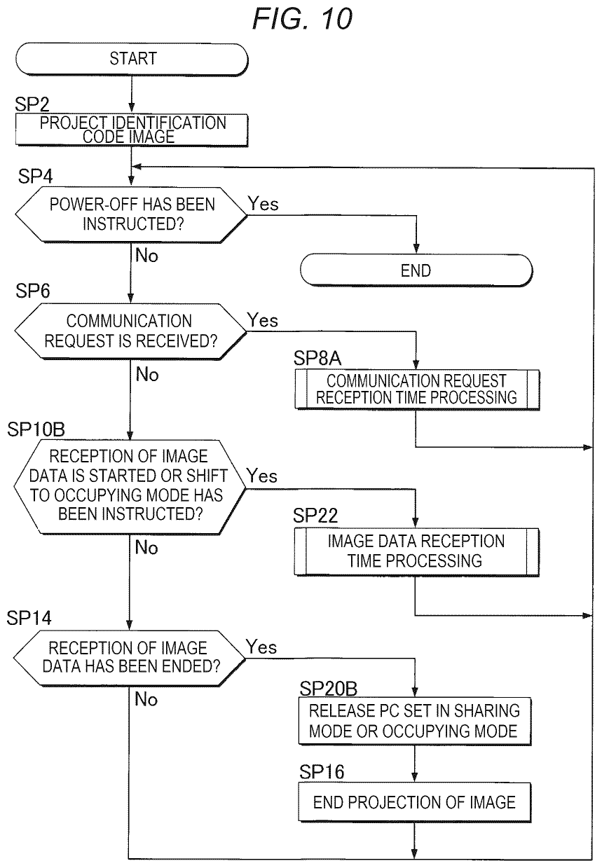

FIG. 10 is a flowchart illustrating an example of an operation of the projector 20 in the second modification. The flowchart illustrated in FIG. 10 is different from the flowchart illustrated in FIG. 8 in that processing in step SP10B is executed instead of the processing in step SP10, processing in step SP22 is executed when a determination result in step SP10B is affirmative, and processing in step SP20B is executed instead of the processing in step SP20 and is the same as the flowchart illustrated in FIG. 8 in other parts. Only differences from the flowchart illustrated in FIG. 8 are explained below.

When the determination result in step SP6 is negative, in step SP10B, the processing circuit 21 determines whether reception of image data has been started or whether transition to an occupying mode has been instructed by the presenter U of the PC 10. The occupying mode is a mode for displaying, in the projection region PR, while occupying the projection region PR, an image based on image data transmitted from one PC 10 among the three or more PCs 10 provided in the display system 1. In the following description, the PC 10 in which the occupying mode is set is sometimes described as “occupying PC 10_o”. The occupying mode is an example of a “second mode”. The instruction to shift to the occupying mode is, for example, a “shift to occupying mode” button displayed on the display 17 of the PC 10 being pressed.

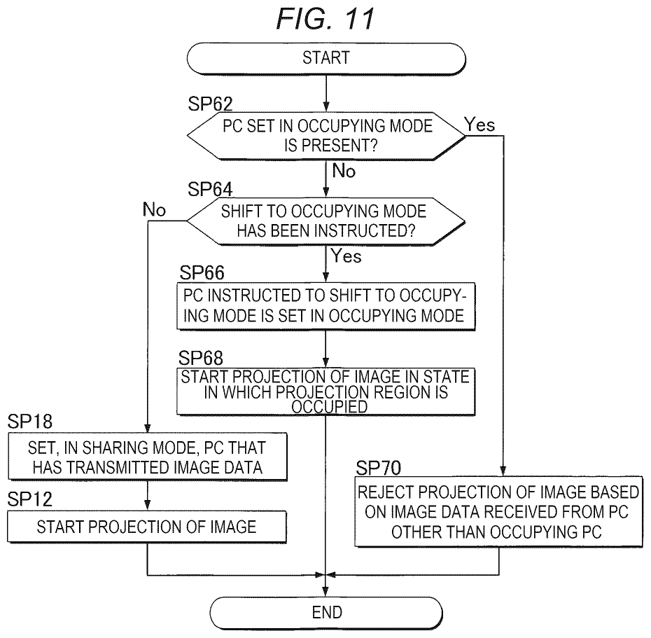

When a determination result in step SP10B is negative, the processing circuit 21 executes the processing in step SP14. When the determination result in step SP10B is affirmative, the processing circuit 21 executes image data reception time processing in step SP22. The image data reception time processing is explained with reference to FIG. 11.

FIG. 11 is a flowchart illustrating an example of the image data reception time processing. In the flowchart illustrated in FIG. 11, since processing in step SP18 and processing in step SP12 are respectively the same as the processing in step SP18 and the processing in step SP12 in the flowchart illustrated in FIG. 8, the description of the processing is omitted. In the following explanation, when step numbers are the same as the step numbers already described, it is assumed that the processing has already been explained and the explanation thereof is omitted.

In step SP62, the processing circuit 21 determines whether the PC 10 for which the occupying mode is set among the three or more PCs 10 provided in the display system 1 is present.

When a determination result in step SP62 is negative, in step SP64, the processing circuit 21 determines whether the transition to the occupying mode has been instructed. When a determination result in step SP64 is negative, the processing circuit 21 executes the processing in step SP18. After the processing in step SP18 ends, the projection device 27 executes the processing in step SP12. After the processing in step SP12 ends, the processing circuit 21 ends a series of processing illustrated in FIG. 11.

When the determination result in step SP64 is affirmative, in step SP66, the processing circuit 21 sets, in the occupying mode, the PC 10 instructed to transition to the occupying mode. Subsequently, in step SP68, the projection device 27 starts, based on an instruction from the processing circuit 21, projecting an image based on the received image data in a state in which the projection region PR is occupied. Specifically, when image data is received from two or more PCs 10, the projection device 27 releases the division of the projection region PR and projects an image based on image data transmitted from the PC 10 set in the occupying mode, that is, the occupying PC 10_o. After the processing in step SP68 ends, the processing circuit 21 ends the series of processing illustrated in FIG. 11.

When the determination result in step SP62 is affirmative, in step SP70, the processing circuit 21 rejects projection of an image based on image data received from the PC 10 other than the occupying PC 10_o. After the processing in step SP70 ends, the processing circuit 21 ends the series of processing illustrated in FIG. 11.

Reference is made to FIG. 10 again. When the determination result in step SP14 is affirmative, in step SP20B, the processing circuit 21 releases the PC 10 set in the sharing mode or the occupying mode. Specifically, the processing circuit 21 releases the sharing mode when the PC 10 that has ended the reception of the image data is the sharing source PC 10_c and releases the occupying mode when the PC 10 that has ended the reception of the image data is the occupying PC 10_o. After the processing in step SP20B ends, the processing circuit 21 executes step SP16.

In order to avoid complication of the figure, in FIG. 10, illustration about a case in which the release of the occupying mode is instructed by the presenter U of the PC 10 is omitted. When the release of the occupying mode is instructed by the presenter U of the PC 10, the projector 20 releases the PC 10 set in the occupying mode. The instruction to release the occupying mode is, for example, a “release occupying mode” button displayed on the display 17 of the PC 10 being pressed. When image data is received from two or more PCs 10 as a result of releasing the occupying mode, the projection device 27 projects, in regions obtained by dividing the projection region PR, an image based on the image data received from each of the two or more PCs 10.

### 2-2-2. Summary of the Second Modification

In the following description, a summary of the second modification is explained using an example in which the communication between the PC 10_1 and the projector 20 is described as first communication, the communication between the PC 10_2 and the projector 20 is described as second communication, the communication between the PC 10_3 and the projector 20 is described as third communication, and the PC 10_1 and the PC 10_2 are set as management authority PCs.

In the display system 1 according to the second modification, there are three or more PCs 10 as the plurality of PCs 10, each of the three or more PCs 10 includes the display 17, and the first communication and the second communication are established. One PC 10 of the PC 10_1 and the PC 10_2 is set in the occupying mode. One PC 10 is an example of “one device”. When the authorization of the third communication is requested from the PC 10_3 among the three or more PCs 10 while an image is displayed in the projection region PR, the projector 20 notifies, to the unshared PC 10_d, authorization request information indicating that the authorization of the third communication has been requested. The unshared PC 10_d is an example of “the other device”. The unshared PC 10_d outputs, to the display 17_d of the unshared PC 10_d, communication determination image data, which is information for causing a user of the other device to determine whether to approve the authorization of the third communication. When receiving, from the unshared PC 10_d, approval information indicating that the authorization of the third communication is approved, the projector 20 establishes the third communication and, after the third communication is established, when being requested to display an image based on image data transmitted from the other PC 10 other than the PC 10 set in the occupying mode among the three or more PCs 10, in step SP70, the projector 20 refuses to display the image based on the image data transmitted from the other PC 10 on the projector 20. In this example, the other PC 10 is the other PC 10 and the PC 10_3. The other PC 10 is an example of “other device”.

According to the second modification, by setting the occupying mode, even if erroneous operation of the presenter U of the PC 10 other than the PC 10 set in the occupying mode occurs, it is possible to prevent an image based on image data transmitted from the PC 10 other than the PC 10 set in the occupying mode from being projected onto the projection region PR. An example of the erroneous operation is explained. A premise is a state in which there are four PCs 10 provided in the display system 1, the PC 10_1 is the occupying PC 10_o, the PC 10_2 and the PC 10_3 are the unshared PC 10_d, and communication between a PC 10_4 and the projector 20 is not established. Based on this premise, when a request for communication with the projector 20 is transmitted from the PC 10_4 to the projector 20, the projector 20 transmits authorization request information to the PC 10_2 and the PC 10_3. A situation could occur in which, immediately before the presenter U_2 presses the button BTN1 or the button BTN2 of the communication determination image CW, a presenter U_3 presses the button BTN1 or the button BTN2 of the communication determination image CW. In this situation, since the projector 20 transmits determination completion information to the PC 10_2, the communication determination image CW displayed on the display 17_2 is erased. Therefore, erroneous operation could occur in which the presenter U_2 presses an operation button or the like superimposed on the communication determination image CW when the presenter U_2 intends to press the button BTN1 or the button BTN2 of the communication determination image CW. Even if such erroneous operation occurs, according to the second modification, it is possible to prevent the image based on the image data transmitted from the PC 10 other than the PC 10 set in the occupying mode from being projected onto the projection region PR.

### 2-3. Third Modification

The third modification is different from the second modification in that a PC can be set in a mode for not updating an image to be displayed by the projector 20. A third modification is explained below.

### 2-3-1. Operation of the Third Modification

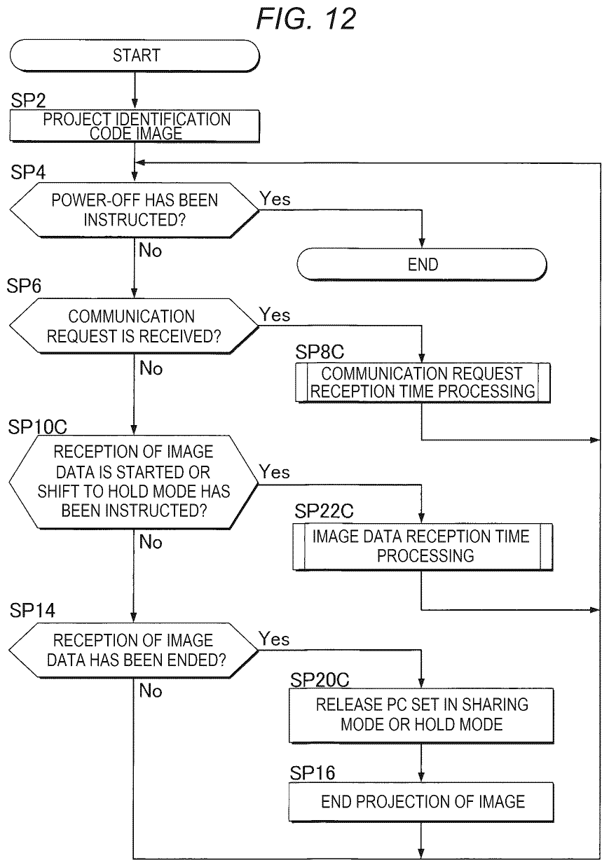

FIG. 12 is a flowchart illustrating an example of the operation of the projector 20 in the third modification. The flowchart illustrated in FIG. 12 is different from the flowchart illustrated in FIG. 10 in that processing in step SP8C is executed instead of the processing in step SP8A, processing in step SP10C is executed instead of the processing in step SP10B, and processing in step SP22C is executed instead of the processing in step SP22 and is the same as the flowchart illustrated in FIG. 10 in other parts. Only differences from the flowchart illustrated in FIG. 10 are explained.

To facilitate explanation, the processing in step SP8C is explained after the processing in step SP20C is explained. When the determination result in step SP6 is negative, in step SP10C, the processing circuit 21 determines whether reception of image data has been started or whether shift to the hold mode has been instructed by the presenter U of the PC 10. The hold mode is a mode for not updating an image to be displayed by the projector 20. The instruction to shift to the hold mode is, for example, a “shift to hold mode” button displayed on the display 17 of the PC 10 being pressed.

The hold mode for not updating an image to be displayed by the projector 20 includes continuing to update the same image. In the following description, the PC 10 set in the hold mode is sometimes described as “hold PC 10_s”. The hold mode is an example of a “third mode”.

The hold mode is useful when, during the sharing mode, the presenter U causes the PC 10 to execute processing that the presenter U does not want the audience W to see. The processing that the presenter U does not want the audience W to see is, for example, processing of inputting personal information such as an account ID and a password.

In order to implement the hold mode, the projector 20 stops updating an image based on image data after the PC 10 is set in the hold mode. In the following description, the image data after the PC 10 is set in the holding mode is sometimes described as “image data after hold”.

As a method of implementing the hold mode, there are three methods explained below. In a first method of implementing the hold mode, when being instructed to be in the hold mode from the presenter U, the hold PC 10_s temporarily stops transmission of image data to the projector 20. The projector 20 continues to project an image based on image data transmitted last from the hold PC 10_s. That is, in the first method of implementing the hold mode, the hold PC 10_s does not transmit the image data after hold to the projector 20.

In a second method of implementing the hold mode, when being instructed to be in the hold mode from the presenter U, the hold PC 10_s temporarily stops transmission of image data to the projector 20. The projector 20 continues to project an image indicated by image data stored in advance in the storage circuit 22. That is, in the second method of implementing the hold mode, the hold PC 10_s does not transmit the image data after hold to the projector 20. The image indicated by the image data stored in advance in the storage circuit 22 may be any image and is, for example, an image including a character string indicating the hold mode. The image indicated by the image data stored in advance in the storage circuit 22 may be a moving image.

In a third method of implementing the hold mode, when being instructed to be in the hold mode from the presenter U, the hold PC 10_s continues transmission of image data to the projector 20. The projector 20 stores image data transmitted from the hold PC 10_s in the storage circuit 22 at a point in time when being instructed to be in the hold mode from the presenter U and continues to project an image based on the stored image data. That is, in the second method of implementing the hold mode, the hold PC 10_s transmits image data after hold to the projector 20 but the projector 20 does not project an image based on the image data after hold. In the following description, an aspect in which the first method of implementing the hold mode is adopted is explained.

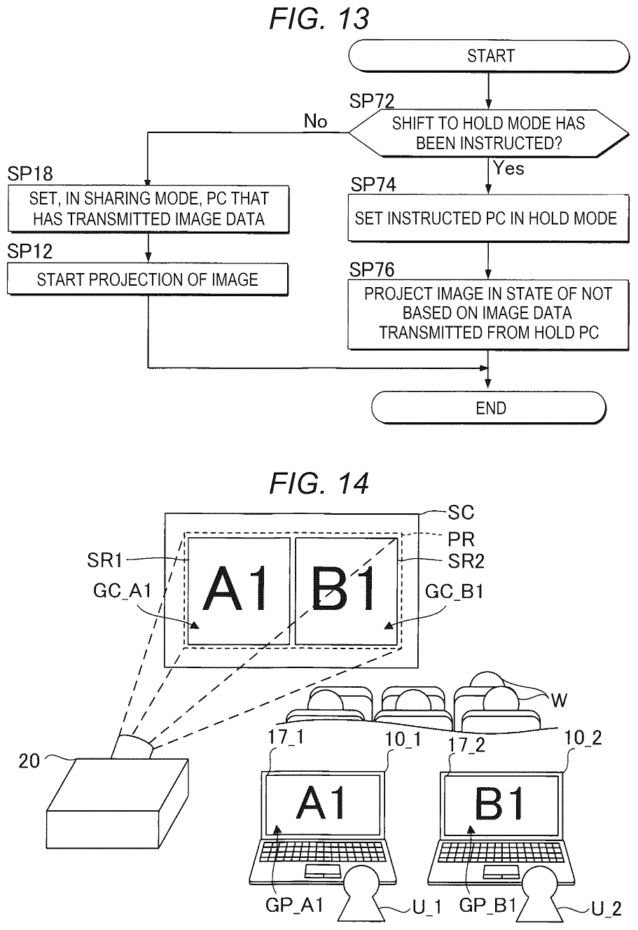

When the determination result in step SP10C is affirmative, in step SP22C, the processing circuit 21 executes image data reception time processing in the third modification. The image data reception time processing in the third modification is explained with reference to FIG. 13.

FIG. 13 is a flowchart illustrating an example of an operation of the image data reception time processing in the third modification. In step SP72, the processing circuit 21 determines whether shift to the hold mode has been instructed. When a determination result in step SP72 is negative, the processing circuit 21 executes the processing in step SP18. After the processing in step SP18 ends, the projection device 27 executes the processing in step SP12. After the processing in step SP12 ends, the processing circuit 21 ends a series of processing illustrated in FIG. 13.

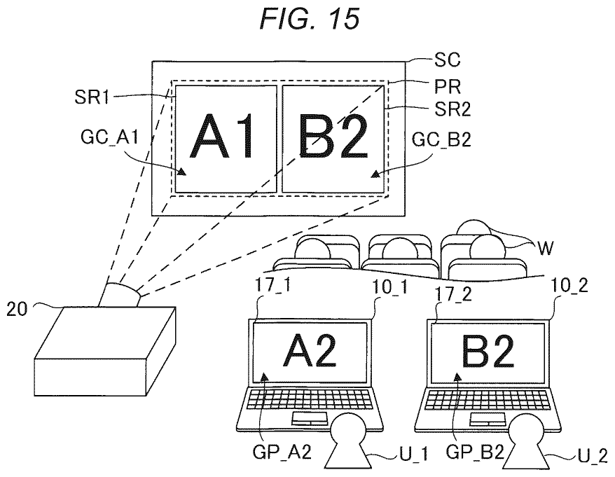

When the determination result in step SP72 is affirmative, in step SP74, the processing circuit 21 sets, in the hold mode, the PC 10 instructed to shift to the hold mode. After the processing in step SP74 ends, in step SP76, the projection device 27 projects, based on an instruction of the processing circuit 21, an image in a state not based on the image data transmitted from the hold PC 10_s. After the processing in step SP76 ends, the processing circuit 21 ends the series of processing illustrated in FIG. 13. A state immediately before a change to the hold mode is explained with reference to FIG. 14. A state after the change to the hold mode is explained with reference to FIG. 15.

FIG. 14 is a diagram illustrating the state immediately before the change to the hold mode. FIG. 15 is a diagram illustrating the state after the change to the hold mode. As a premise common to FIGS. 14 and 15, the PC 10_1 and the PC 10_2 are the sharing source PC 10_c. Therefore, the projector 20 divides the projection region PR into two regions, that is, a partial region SR1 and a partial region SR2. The partial region SR1 and the partial region SR2 may be respective regions obtained by equally dividing the projection region PR into two or may be regions obtained by unequally dividing the projection region PR. Further, the projection region PR may include a region that is not included in both of the partial region SR1 and the partial region SR2.

In an example illustrated in FIG. 14, the projector 20 projects an image GC_A1 based on image data transmitted from the PC 10_1 onto the partial region SR1 and projects an image GC_B1 based on image data transmitted from the PC 10_2 onto the partial region SR2. The image GC_A1 is the same as the image GP_A1 displayed on the display 17_1. The image GC_B1 is the same as the image GP_B1 displayed on the display 17_2. As explained above, in the example illustrated in FIG. 14, a premise is that the shared image in the first aspect, that is, the mirroring image is projected before the change to the hold mode. The partial region SR1 is an example of a “first partial region” and the partial region SR2 is an example of a “second partial region”. The image data transmitted from the PC 10_1 is an example of “first image data” and the image data transmitted from the PC 10_2 is an example of “second image data”.

In the state illustrated in FIG. 14, it is assumed that the presenter U_1 instructs the PC 10_1 to change the sharing mode to the hold mode.

In the example illustrated in FIG. 15, the projector 20 stops updating an image in the partial region SR1 based on image data after the PC 10_1 is set in the hold mode. Therefore, in the example illustrated in FIG. 15, an image displayed on the display 17_1 is updated from the image GP_A1 to the image GP_A2 but an image projected onto the partial region SR1 remains as the image GC_A1. On the other hand, concerning the PC 10_2 that remains in the sharing mode, the projector 20 continues to update the image in the partial region SR2. That is, in the example illustrated in FIG. 15, the image displayed on the display 17_2 is updated from the image GP_B1 to the image GP_B2, the image projected onto the partial region SR2 is updated from the image GC_B1 to the image GC_B2, and the image GP_B2 and the image GC_B2 are the same.

Reference is made to FIG. 12 again. When the determination result in step SP10C is negative, the processing circuit 21 executes the processing in step SP14. When the determination result in step SP14 is affirmative, in step SP20C, the processing circuit 21 releases the PC 10 set in the sharing mode or the hold mode. Specifically, the processing circuit 21 releases the sharing mode if the PC 10 that has ended the reception of the image data is the sharing source PC 10_c and releases the hold mode if the PC 10 that has ended the reception of the image data is the hold PC 10_s. As a result of releasing the hold mode, the projector 20 resumes update of an image based on image data transmitted from the PC 10 after the hold mode is released. After the processing in step SP20C ends, the processing circuit 21 executes step SP16.

In order to avoid complication of the figure, in FIG. 12, illustration about a case in which release of the hold mode is instructed by the presenter U of the PC 10 is omitted. When the release of the hold mode is instructed by the presenter U of the PC 10, the projector 20 releases the PC 10 set in the hold mode.

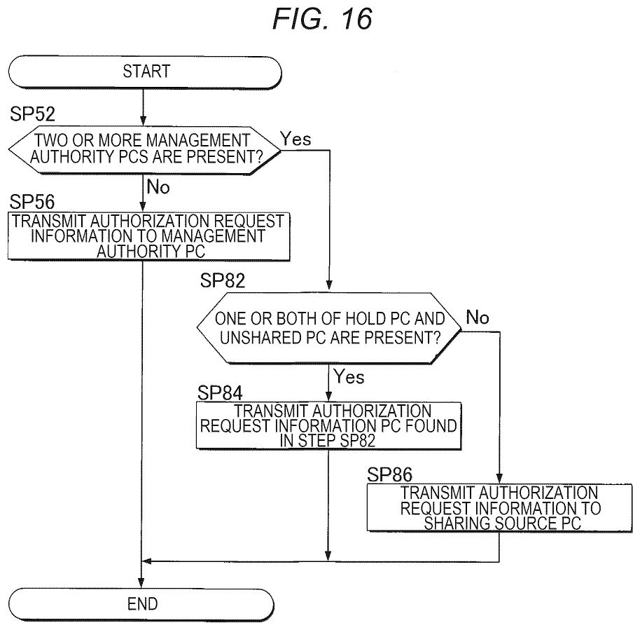

When the determination result in step SP6 is affirmative, in step SP8C, the processing circuit 21 executes the communication request reception time processing in the third modification. The communication request reception time processing in the third modification example is different from the flowchart illustrated in FIG. 6 in that authorization request information transmission processing is executed instead of the processing in step SP42 illustrated in FIG. 6 and is the same as the flowchart illustrated in FIG. 6 in other parts. Therefore, illustration of the communication request reception time processing in the third modification is omitted, and authorization request information transmission processing is explained with reference to FIG. 16.

FIG. 16 is a flowchart illustrating an example of the authorization request information transmission processing. When the determination result in step SP52 is negative, the processing circuit 21 executes the processing in step SP56 and ends a series of processing illustrated in FIG. 16. When the determination result in step SP52 is affirmative, in step SP82, the processing circuit 21 determines whether one or both of the hold PC 10_s and the unshared PC 10_d among the three or more PCs 10 provided in the display system 1 are present.

When a determination result in step SP82 is affirmative, in step SP84, the communication circuit 24 transmits authorization request information to the PC 10 found in step SP82 under an instruction of the processing circuit 21. Specifically, when there are both the hold PC 10_s and the unshared PC 10_d, the communication circuit 24 transmits the authorization request information to the hold PC 10_s and the unshared PC 10_d. When there is only the hold PC 10_s, the communication circuit 24 transmits the authorization request information to the hold PC 10_s, and when there is only the unshared PC 10_d, the communication circuit 24 transmits the authorization request information to the unshared PC 10_d. For example, when receiving the authorization request information, the hold PC 10_s displays the communication determination image CW on the display 17_s. After the processing in step SP84 ends, the processing circuit 21 ends the series of processing illustrated in FIG. 16.

When the determination result in step SP82 is negative, in step SP86, the communication circuit 24 transmits authorization request information to the sharing source PC 10_c under an instruction of the processing circuit 21. After the processing in step SP86 ends, the processing circuit 21 ends the series of processing illustrated in FIG. 16.

### 2-3-2. Summary of the Third Modification

In the following description, communication between the PC 10_1 and the projector 20 is described as first communication, communication between the PC 10_2 and the projector 20 is described as second communication, communication between the PC 10_3 and the projector 20 is described as third communication, image data transmitted from the PC 10_1 is described as first image data, and image data transmitted from the PC 10_2 is described as second image data. Furthermore, in the following description, a summary of the third modification is explained using an example in which the PC 10_1 and the PC 10_2 are set as the management authority PCs.

In the display system 1 in the third modification, there are three or more PCs 10 as the plurality of PCs 10, each of the three or more PCs 10 includes the display 17, and the first communication and the second communication are established. Both of the PC 10_1 and the PC 10_2 are set in the sharing mode. An image based on the first image data transmitted from the PC 10_1 is displayed in the partial region SR1 that is a part of the projection region PR, and an image based on the second image data transmitted from the PC 10_2 is displayed in the partial region SR2 that is a part of the projection region PR and is different from the partial region SR1. When the PC 10_1 is set in the hold mode in which an image to be displayed by the projector 20 is not updated, the projector 20 stops update of the image in the partial region SR1 based on the first image data after the PC 10_1 is set in the hold mode and, when the PC 10_2 is set in the hold mode, the projector 20 stops update of the image in the partial region SR2 based on the second image data after the PC 10_2 is set in the hold mode. When authorization of the third communication is requested from the PC 10_3 among the three or more PCs 10 while an image is displayed in the projection region PR, the projector 20 transmits authorization request information indicating that the authorization of the third communication has been requested to the PC 10 set in the hold mode, that is, the hold PC 10_s. The hold PC 10_s outputs communication determination image data, which is information for causing the presenter U of the hold PC 10_s to determine whether to approve the authorization of the third communication, to the display 17_s of the hold PC 10_s. When receiving approval information indicating that the authorization of the third communication is approved from the hold PC 10_s, the projector 20 establishes the third communication.

According to the third modification, by transmitting the authorization request information to the hold PC 10_s, it is possible to establish the communication between the PC 10_3 and the projector 20 while preventing the display of the image displayed on the display 17 of the sharing source PC 10_c from being hindered.

### 2-4. Fourth Modification

A fourth modification is different from the first modification in that the authorization request information is prevented from being transmitted to the sharing source PC 10_c that transmits the image data indicating the mirroring image. The fourth modification is explained below.

### 2-4-1. Operation of the Fourth Modification

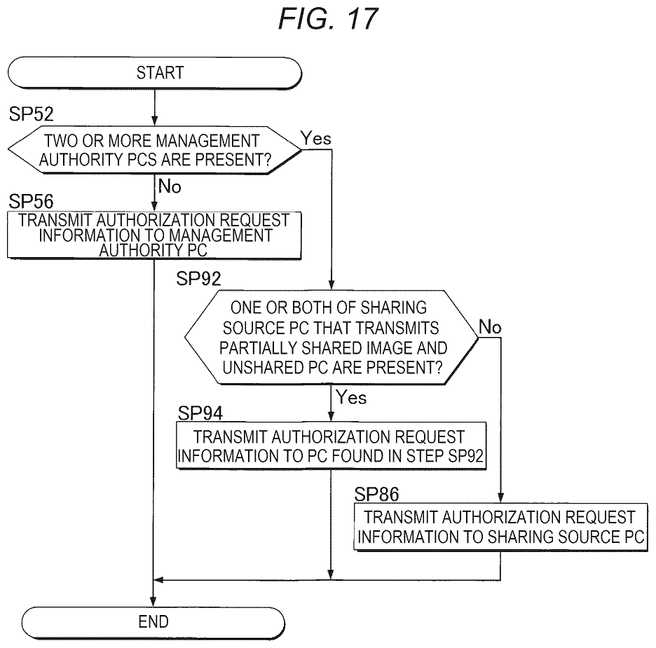

In the fourth modification, authorization request information transmission processing in the fourth modification illustrated in FIG. 17 is executed instead of not executing the processing in step SP52, the processing in step SP54, and the processing in step SP56 in the communication request reception time processing in the first modification illustrated in FIG. 9.

FIG. 17 is a flowchart illustrating an example of authorization request information transmission processing in the fourth modification. When the determination result in step SP52 is negative, the processing circuit 21 executes the processing in step SP56 and ends a series of processing illustrated in FIG. 17. When the determination result in step SP52 is affirmative, in step SP92, the processing circuit 21 determines whether one or both of the sharing source PC 10_c that transmits a partially shared image and the unshared PC 10_d among the three or more PCs 10 provided in the display system 1 are present.

In a connection protocol defining an image data transmission method, a field for setting an identifier indicating whether a shared image indicated by image data transmitted by the PC 10 is a mirroring image or a partially shared image is specified. By referring to the identifier set in this field, the processing circuit 21 can determine whether the shared image indicated by the image data transmitted by the PC 10 is the mirroring image or the partially shared image.

When a determination result in step SP92 is affirmative, in step SP94, the communication circuit 24 transmits authorization request information to the PC 10 found in step SP92 under an instruction of the processing circuit 21. Specifically, when there are both of the sharing source PC 10_c that transmits the partially shared image and the unshared PC 10_d, the communication circuit 24 transmits the authorization request information to the sharing source PC 10_c that transmits the partially shared image and the unshared PC 10_d. When there is only the sharing source PC 10_c that transmits the partially shared image, the communication circuit 24 transmits the authorization request information to the sharing source PC 10_c that transmits the partially shared image and, when there is only the unshared PC 10_d, the communication circuit 24 transmits the authorization request information to the unshared PC 10_d. For example, when the sharing source PC 10_c that transmits the partially shared image receives the authorization request information, the sharing source PC 10_c that transmits the partially shared image displays the communication determination image CW on the display 17_s. After the processing in step SP94 ends, the processing circuit 21 ends the series of processing illustrated in FIG. 17.

When the determination result in step SP92 is negative, the processing circuit 21 executes the processing in step SP86 and ends the series of processing illustrated in FIG. 17.

### 2-4-2. Summary of the Fourth Modification

In the following description, for simplification of explanation, the communication between the PC 10_1 and the projector 20 is described as first communication, the communication between the PC 10_2 and the projector 20 is described as second communication, the communication between the PC 10_3 and the projector 20 is described as third communication, the image data transmitted from the PC 10_1 is described as first image data, and the image data transmitted from the PC 10_2 is described as second image data. Furthermore, in the following description, a summary of the fourth modification is explained using an example in which the PC 10_1 and the PC 10_2 are set as the management authority PCs.

In the display system 1 according to the fourth modification, there are three or more PCs 10 as the plurality of PCs 10, each of the three or more PCs 10 includes the display 17, the first communication and the second communication are established, and both of the PC 10_1 and the PC 10_2 are set in the sharing mode. An image that one PC 10 of the PC 10_1 and the PC 10_2 causes the projector 20 to display is the mirroring image and an image that the other PC 10 of the PC 10_1 and the PC 10_2 causes the projector 20 to project is the partially shared image. When the authorization of the third communication is requested from the PC 10_3 among the three or more PCs 10 while an image is displayed in the projection region PR, the projector 20 notifies the other PC 10 that the authorization of the third communication has been requested. The other PC 10 outputs, to the display 17 of the other PC 10, communication determination image data that is information for causing the presenter U of the other PC 10 to determine whether to approve the authorization of the third communication. When receiving, from the other PC 10, approval information indicating that the authorization of the third communication has been approved, the projector 20 establishes the third communication.

According to the fourth modification, by transmitting the authorization request information to the sharing source PC 10_c that causes the projector 20 to project the partially shared image, it is possible to establish communication between the PC 10_3 and the projector 20 while preventing the display of the mirroring image displayed on the display 17 of the sharing source PC 10_c from being hindered. Further, since a portion different from the partially shared image is present in the image displayed on the display 17 of the sharing source PC 10_c that causes the projector 20 to project the partially shared image, it is likely that the communication determination image CW is displayed at a position where the presenter U_c of the sharing source PC 10_c that causes the projector 20 to project the partially shared image does not feel annoyed. Therefore, according to the fourth modification, it is possible to further reduce the possibility that the presenter U_c feels annoyed compared with the aspect in which the authorization request information is transmitted to the PC 10_c that causes the projector 20 to project the mirroring image.

### 2-5. Fifth Modification

In the aspects explained above, the projector 20 is an example of the “monitor” but is not limited to this. For example, another example of the monitor may be an organic EL display or a liquid crystal display. EL is an abbreviation of Electro Luminescence.

### 2-6. Sixth Modification

In the aspects explained above, the display 17 provided in the PC 10 is explained as an example of the output destination of the information for causing the presenter U_1 to determine whether to approve the authorization of communication. However, the output destination is not limited to the display 17. For example, the PC 10 includes an earphone and the presenter U wears the earphone. The PC 10 may reproduce, to the earphone, voice indicating information for causing the presenter U_1 to determine whether to approve authorization of communication between the PC 10 and the projector 20 and voice for prompting approval or disapproval of the authorization of the communication. The voice indicating the information for causing the presenter U_1 to determine whether to approve the authorization of the communication between the PC 10 and the projector 20 is, for example, “Approve the authorization of the communication between the projector 20 and the PC 10_2?”. The voice for prompting the approval or disapproval of the authorization of the communication is, for example, “Please press the determination key if approving the authorization of the communication and press the cancel key if disapproving the authorization of the communication”. When the determination key is pressed, the PC 10 transmits approval information to the projector 20 and, when the cancel key is pressed, the PC 10 transmits disapproval information to the projector 20.

### 2-7. Seventh Modification

In the aspects explained above, the projector 20 transmits the determination completion information to the management authority PC 10_m that has not transmitted both of the approval information and the disapproval information among the management authority PCs 10_m that have transmitted the authorization request information but may not transmit the determination completion information.

### 2-8. Eighth Modification

In the first modification and the aspects based on the first modification, the shared image in the second aspect is the partial image of the image displayed on the display 17_c but is not limited to this. For example, the shared image in the second aspect may be an image obtained by superimposing another image on the image displayed on the display 17_c.

### 3. Appendixes

The present disclosure is summarized below as appendixes.

(Appendix 1) A method of, in a display system including a plurality of communication terminals and a monitor capable of communicating with the plurality of communication terminals, controlling communication with the monitor, the method including: establishing, with the monitor capable of displaying an image in a display region, first communication with a first communication terminal among the plurality of communication terminals; when authorization of second communication between a second communication terminal among the plurality of communication terminals and the monitor is requested from the second communication terminal while the image is displayed in the display region, transmitting, with the monitor, to the first communication terminal, information indicating that the authorization of the second communication is requested; outputting, with the first communication terminal, to the first communication terminal, information for causing a user of the first communication terminal to determine whether to approve the authorization of the second communication; and establishing, with the monitor, the second communication when information indicating that the authorization of the second communication was approved is received from the first communication terminal. According to Appendix 1, it is possible to establish communication between the second communication terminal and the monitor while preventing the display of the image based on the image data transmitted from the first communication terminal in the display region from being hindered.

(Appendix 2) The method of controlling the communication with the monitor described in Appendix 1, wherein the plurality of communication terminals are three or more devices, each of the three or more communication terminals includes a display, the first communication and the second communication are established, and the method further includes: when authorization of third communication between a third communication terminal among the three or more communication terminals and the monitor is requested from the third communication terminal while the image is displayed in the display region, transmitting, with the monitor, to the first communication terminal and the second communication terminal, information indicating that authorization of the third communication is requested; outputting, with the first communication terminal, to a display of the first communication terminal, information for causing the user of the first communication terminal to determine whether to approve the authorization of the third communication; outputting, with the second communication terminal, to a display of the second communication terminal, information for causing a user of the second communication terminal to determine whether to approve the authorization of the third communication; and establishing, with the monitor, the third communication when information indicating that the authorization of the third communication was approved is received from at least one device of the first communication terminal and the second communication terminal. According to Appendix 2, it is possible to prevent the approval of the authorization of the third communication from being delayed because of a deficiency such as a delay in communication of the display system or carelessness of the user compared with an aspect in which one user determines whether to approve the authorization of the third communication.

(Appendix 3) The method of controlling the communication with the monitor described in Appendix 1, wherein the plurality of communication terminals are three or more communication terminals, each of the three or more communication terminals includes a display, the first communication and the second communication are established, one device of the first communication terminal and the second communication terminal is set in a first mode for causing the monitor to display a first image based on image data transmitted from one or more communication terminals among the three or more communication terminals, and the method further includes: when authorization of third communication between a third communication terminal among the three or more communication terminals and the monitor is requested from the third communication terminal while the first image is displayed in the display region, transmitting, with the monitor, to another device, information indicating that authorization of the third communication is requested; outputting, with the other device, to a display of the other device, information for causing a user of the other device to determine whether to approve the authorization of the third communication; and establishing, with the monitor, the third communication when information indicating that the authorization of the third communication was approved is received from the other device. According to Appendix 3, since the other device that is not causing the monitor to display an image outputs, to the display, the information for causing the user of the other device to determine whether to approve the authorization of the third communication, it is possible to prevent the user of one device that is causing the monitor to display an image from being annoyed.

(Appendix 4) The method of controlling the communication with the monitor described in Appendix 3, wherein, the first image is the same as an image displayed on the display of the one device. According to Appendix 4, since it is possible to prevent information for causing the user of one device to determine whether to approve the authorization of the third communication from being displayed on the same image as the image displayed by the monitor, it is possible to prevent the user of one device from feeling annoyed.

(Appendix 5) The method of controlling the communication with the monitor described in Appendix 3, wherein the first image is different from an image displayed on the display of the one device. According to Appendix 5, since it is possible to prevent information for causing the user of one device to determine whether to approve the authorization of the third communication from being superimposed and displayed on information concerning the image projected by the monitor, it is possible to prevent the user of one device from feeling annoyed.

(Appendix 6) The method of controlling the communication with the monitor described in Appendix 1, wherein the plurality of communication terminals are three or more communication terminals, each of the three or more communication terminals includes a display, the first communication and the second communication are established, one device of the first communication terminal and the second communication terminal is set in a second mode for, while occupying the display region, causing the display region to display an image based on image data transmitted from one device among the three or more communication terminals, and the method further includes: when authorization of third communication between a third communication terminal among the three or more communication terminals and the monitor is requested from the third communication terminal while the image is displayed in the display region, transmitting, with the monitor, to another device, information indicating that the authorization of the third communication is requested; outputting, with the other device, to a display of the other device, information for causing a user of the other device to determine whether to approve the authorization of the third communication; establishing, with the monitor, the third communication when information indicating that the authorization of the third communication was approved is received from the other device; and, when it is requested to cause the monitor to display an image based on image data transmitted from another device other than a communication terminal set in the second mode among the three or more communication terminals after the third communication is established, refusing to cause the monitor to display the image based on the image data transmitted from the other device. According to Appendix 6, by setting the second mode, even if erroneous operation by a user of a device other than the communication terminal set in the second mode occurs, it is possible to prevent an image based on image data transmitted from the device other than the communication terminal set in the second mode from being projected onto the projection region.

(Appendix 7) The method of controlling the communication with the monitor described in Appendix 1, wherein the plurality of communication terminals are three or more communication terminals, each of the three or more communication terminals includes a display, the first communication and the second communication are established, both the first communication terminal and the second communication terminal are set in a first mode for causing the monitor to display an image based on image data transmitted from one or more communication terminals among the three or more communication terminals, an image based on first image data transmitted from the first communication terminal is displayed in a first partial region that is a part of the display region, and an image based on second image data transmitted from the second communication terminal is displayed in a second partial region that is a part of the display region and is different from the first partial region, and the method further includes: when the first communication terminal is set in a third mode for not updating an image to be displayed on the monitor, stopping, with the monitor, update of the image in the first partial region based on the first image data after the first communication terminal is set in the third mode and, when the second communication terminal is set in the third mode, stopping, with the monitor, update of the image in the second partial region based on the second image data after the second communication terminal is set in the third mode; when authorization of third communication between a third communication terminal among the three or more communication terminals and the monitor is requested from the third communication terminal while the image is displayed in the display region, transmitting, with the monitor, to a communication terminal set in the third mode, information indicating that the authorization of the third communication is requested; outputting, with the communication terminal set in the third mode, to a display of the communication terminal set in the third mode, information for causing a user of the communication terminal set in the third mode to determine whether to approve the authorization of the third communication; and, establishing, with the monitor, the third communication when information indicating that the authorization of the third communication was approved is received from the communication terminal set in the third mode. According to Appendix 7, by transmitting, to the communication terminal set in the third mode, the information for causing the user of the communication terminal set in the third mode to determine whether to approve the authorization of the third communication, it is possible to establish the communication between the third communication terminal and the monitor while preventing the display of the image displayed on the display of the communication terminal set in the first mode from being hindered.

(Appendix 8) The method of controlling the communication with the monitor described in Appendix 2, wherein, in response to receiving, from one device of the first communication terminal and the second communication terminal, information indicating that the authorization of the third communication was approved or information indicating that the authorization of the third communication was disapproved, the monitor transmits, to another device of the first communication terminal and the second communication terminal, information indicating that the determination of whether to approve the authorization of the third communication was completed. According to Appendix 8, since the information indicating that the determination of whether to approve the authorization of the third communication is completed is transmitted to the other device, the information for causing the user of the other device to determine whether to approve the authorization of the third communication, which is displayed on the display of the other device, can be erased. Therefore, it is possible to reduce a burden of operation on the user of the other device.

(Appendix 9) The method of controlling the communication with the monitor described in Appendix 1, wherein the plurality of communication terminals are three or more communication terminals, each of the three or more communication terminals includes a display, the first communication and the second communication are established, both the first communication terminal and the second communication terminal are set in a first mode for causing the monitor to display an image based on image data transmitted from one or more communication terminals among the three or more communication terminals, an image that one device of the first communication terminal and the second communication terminal causes the monitor to display is the same as an image displayed on a display of the one device, and an image that another device of the first communication terminal and the second communication terminal causes the monitor to display is different from an image displayed on a display of the other device, and the method further includes: when authorization of third communication between a third communication terminal among the three or more communication terminals and the monitor is requested from the third communication terminal while the image is displayed in the display region, transmitting, with the monitor, to the other device, information indicating that the authorization of the third communication is requested; outputting, with the other device, to a display of the other device, information for causing a user of the other device to determine whether to approve the authorization of the third communication; and, establishing, with the monitor, the third communication when information indicating that the authorization of the third communication was approved is received from the other device. According to Appendix 9, it is possible to reduce the possibility that the user of one device feels annoyed compared with an aspect in which information for causing the user of the other device to determine whether to approve the authorization of the third communication is transmitted to one device that causes the monitor to display the same image as the image displayed on the display.

(Appendix 10) A display system including: a plurality of communication terminals; and a monitor capable of communicating with the plurality of communication terminals, wherein the monitor is capable of displaying an image in a display region, first communication between a first communication terminal among the plurality of communication terminals and the monitor is established, when authorization of second communication between a second communication terminal among the plurality of communication terminals and the monitor is requested from the second communication terminal while the image is displayed in the display region, the monitor transmits, to the first communication terminal, information indicating that the authorization of the second communication is requested, the first communication terminal outputs, to the first communication terminal, information for causing a user of the first communication terminal to determine whether to approve the authorization of the second communication, and the monitor establishes the second communication when information indicating that the authorization of the second communication was approved is received from the first communication terminal. According to Appendix 10, the same effect as the effects of Appendix 1 is obtained.

What is claimed is:

1. A method of, in a display system including a plurality of communication terminals and a monitor capable of communicating with the plurality of communication terminals, controlling communication with the monitor, the method comprising:
establishing, with the monitor capable of displaying an image in a display region, first communication with a first communication terminal among the plurality of communication terminals;
when authorization of second communication between a second communication terminal among the plurality of communication terminals and the monitor is requested from the second communication terminal while the image is displayed in the display region, transmitting, with the monitor, to the first communication terminal, information indicating that the authorization of the second communication is requested; and
establishing, with the monitor, the second communication when information indicating that the authorization of the second communication was approved is received from the first communication terminal.

2. The method of controlling the communication with the monitor according to claim 1, further comprising outputting, with the first communication terminal, to the first communication terminal, information for causing a user of the first communication terminal to determine whether to approve the authorization of the second communication.

3. The method of controlling the communication with the monitor according to claim 2, wherein
the plurality of communication terminals are three or more communication terminals,
each of the three or more communication terminals includes a display,
the first communication and the second communication are established, and
the method further comprises:
when authorization of third communication between a third communication terminal among the three or more communication terminals and the monitor is requested from the third communication terminal while the image is displayed in the display region, transmitting, with the monitor, to the first communication terminal and the second communication terminal, information indicating that authorization of the third communication is requested;
outputting, with the first communication terminal, to a display of the first communication terminal, information for causing the user of the first communication terminal to determine whether to approve the authorization of the third communication;
outputting, with the second communication terminal, to a display of the second communication terminal, information for causing a user of the second communication terminal to determine whether to approve the authorization of the third communication; and
establishing, with the monitor, the third communication when information indicating that the authorization of the third communication was approved is received from at least one device of the first communication terminal and the second communication terminal.

4. The method of controlling the communication with the monitor according to claim 2, wherein
the plurality of communication terminals are three or more communication terminals,
each of the three or more communication terminals includes a display,
the first communication and the second communication are established,
one device of the first communication terminal and the second communication terminal is set in a first mode for causing the monitor to display a first image based on image data transmitted from one or more communication terminals among the three or more communication terminals, and
the method further comprises:
when authorization of third communication between a third communication terminal among the three or more communication terminals and the monitor is requested from the third communication terminal while the first image is displayed in the display region, transmitting, with the monitor, to another device of the first communication terminal and the second communication terminal, information indicating that authorization of the third communication is requested; outputting, with the other device, to a display of the other device, information for causing a user of the other device to determine whether to approve the authorization of the third communication; and
establishing, with the monitor, the third communication when information indicating that the authorization of the third communication was approved is received from the other device.

5. The method of controlling the communication with the monitor according to claim 4, wherein, the first image is the same as an image displayed on the display of the one device.

6. The method of controlling the communication with the monitor according to claim 4, wherein the first image is different from an image displayed on the display of the one device.

7. The method of controlling the communication with the monitor according to claim 2, wherein
the plurality of communication terminals are three or more communication terminals,
each of the three or more communication terminals includes a display,
the first communication and the second communication are established,
one device of the first communication terminal and the second communication terminal is set in a second mode for, while occupying the display region, causing the display region to display an image based on image data transmitted from one device among the three or more communication terminals, and
the method further comprises:
when authorization of third communication between a third communication terminal among the three or more communication terminals and the monitor is requested from the third communication terminal while the image is displayed in the display region, transmitting, with the monitor, to another device of the first communication terminal and the second communication terminal, information indicating that the authorization of the third communication is requested;
outputting, with the other device, to a display of the other device, information for causing a user of the other device to determine whether to approve the authorization of the third communication;
establishing, with the monitor, the third communication when information indicating that the authorization of the third communication was approved is received from the other device; and
when it is requested to cause the monitor to display an image based on image data transmitted from another device other than a communication terminal set in the second mode among the three or more communication terminals after the third communication is established, refusing to cause the monitor to display the image based on the image data transmitted from the other device.

8. The method of controlling the communication with the monitor according to claim 2, wherein
the plurality of communication terminals are three or more communication terminals,
each of the three or more communication terminals includes a display,
the first communication and the second communication are established,
both the first communication terminal and the second communication terminal are set in a first mode for causing the monitor to display an image based on image data transmitted from one or more communication terminals among the three or more communication terminals,
an image based on first image data transmitted from the first communication terminal is displayed in a first partial region that is a part of the display region, and
an image based on second image data transmitted from the second communication terminal is displayed in a second partial region that is a part of the display region and is different from the first partial region, and
the method further comprises:
when the first communication terminal is set in a third mode for not updating an image to be displayed on the monitor, stopping, with the monitor, update of the image in the first partial region based on the first image data after the first communication terminal is set in the third mode and, when the second communication terminal is set in the third mode, stopping, with the monitor, update of the image in the second partial region based on the second image data after the second communication terminal is set in the third mode;
when authorization of third communication between a third communication terminal among the three or more communication terminals and the monitor is requested from the third communication terminal while the image is displayed in the display region, transmitting, with the monitor, to a communication terminal set in the third mode, information indicating that the authorization of the third communication is requested;
outputting, with the communication terminal set in the third mode, to a display of the communication terminal set in the third mode, information for causing a user of the communication terminal set in the third mode to determine whether to approve the authorization of the third communication; and
establishing, with the monitor, the third communication when information indicating that the authorization of the third communication was approved is received from the communication terminal set in the third mode.

9. The method of controlling the communication with the monitor according to claim 3, wherein, in response to receiving, from one device of the first communication terminal and the second communication terminal, information indicating that the authorization of the third communication was approved or information indicating that the authorization of the third communication was disapproved, the monitor transmits, to another device of the first communication terminal and the second communication terminal, information indicating that the determination of whether to approve the authorization of the third communication was completed.

10. The method of controlling the communication with the monitor according to claim 1, wherein
the plurality of communication terminals are three or more communication terminals,
each of the three or more communication terminals includes a display,
the first communication and the second communication are established,
both the first communication terminal and the second communication terminal are set in a first mode for causing the monitor to display an image based on image data transmitted from one or more communication terminals among the three or more communication terminals,
an image that one device of the first communication terminal and the second communication terminal causes the monitor to display is the same as an image displayed on a display of the one device,
an image that another device of the first communication terminal and the second communication terminal causes the monitor to display is different from an image displayed on a display of the other device, and
the method further comprises
when authorization of third communication between a third communication terminal among the three or more communication terminals and the monitor is requested from the third communication terminal while the image is displayed in the display region, transmitting, with the monitor, to the other device, information indicating that the authorization of the third communication is requested;
outputting, with the other device, to a display of the other device, information for causing a user of the other device to determine whether to approve the authorization of the third communication; and
establishing, with the monitor, the third communication when information indicating that the authorization of the third communication was approved is received from the other device.

11. A display system comprising:
a plurality of communication terminals; and
a monitor capable of communicating with the plurality of communication terminals, wherein
the monitor is capable of displaying an image in a display region,
first communication between a first communication terminal among the plurality of communication terminals and the monitor is established,
when authorization of second communication between a second communication terminal among the plurality of communication terminals and the monitor is requested from the second communication terminal while the image is displayed in the display region, the monitor transmits, to the first communication terminal, information indicating that the authorization of the second communication is requested,
the first communication terminal outputs, to the first communication terminal, information for causing a user of the first communication terminal to determine whether to approve the authorization of the second communication, and
the monitor establishes the second communication when information indicating that the authorization of the second communication was approved is received from the first communication terminal.

12. A monitor capable of displaying an image in a display region and capable of communicating with a plurality of communication terminals,
the monitor executing:
establishing first communication between a first communication terminal among the plurality of communication terminals and the monitor;
when authorization of second communication between a second communication terminal among the plurality of communication terminals and the monitor is requested from the second communication terminal while the image is displayed in the display region, transmitting, to the first communication terminal, information indicating that the authorization of the second communication is requested; and
establishing the second communication when information indicating that the authorization of the second communication was approved is received from the first communication terminal.
